(19) United States
(12) Patent Application Publication
(10) Pub. No.: US 2021/0030617 A1
(43) Pub. Date: Feb. 4, 2021

(54) MASSAGE DEVICES AND RELATED METHODS

(71) Applicant: Byron Penn, Eugene, OR (US)

(72) Inventor: Byron Penn, Eugene, OR (US)

(21) Appl. No.: 16/941,139

(22) Filed: Jul. 28, 2020

Related U.S. Application Data
(60) Provisional application No. 62/880,279, filed on Jul. 30, 2019.

(51) Int. Cl. A61H 15/00

(52) U.S. Cl. CPC A61H 15/0078; A61H 2201/0119; A61H 2015/0014; A61H 2015/005

(57) ABSTRACT

Massage devices and associated methods. Massage devices include a frame, a first massage element rotatably supported on a first support member, and a second massage element rotatably supported on a second support member. The first massage element and the second massage element may be separated by a selected separation distance. The massage device may include a separation adjustment mechanism for adjusting the selected separation distance. The separation adjustment mechanism may be configured to be selectively transitioned between a use configuration and an adjustment configuration. Methods of utilizing a massage device to massage a limb may include positioning the limb between a first massage element and a second massage element of the massage device and applying a compressive force to the limb with each of the first massage element and the second massage element.

### RELATED APPLICATION

This application claims priority under 35 U.S.C. § 119(e) to U.S. Provisional Patent Application Ser. No. 62/880,279, which was filed on Jul. 30, 2019, the complete disclosure of which is hereby incorporated by reference.

### FIELD

The present disclosure relates to massage devices and related methods.

### BACKGROUND

Individuals, such as athletes, who experience acute muscle pain, soreness, and/or other discomfort in a limb may utilize manually operated massage devices to alleviate such discomfort. Such devices generally operate to exert a compressive force on the limb. However, conventional massage devices often fail to provide the user with the ability to apply a sufficiently strong compressive force to a sufficiently localized region of the limb and/or across a diversity of limb sizes.

### SUMMARY

Massage devices and associated methods are disclosed herein. Massage devices for massaging a limb of a user include a frame, a first massage element operatively supported by the frame, and a second massage element operatively supported by the frame. The first massage element is supported on a first support member that is operatively coupled to the frame, and is configured to rotate relative to the frame about a first axis of rotation. The second massage element is supported on a second support member that is operatively coupled to the frame, and is configured to rotate relative to the frame about a second axis of rotation. In some examples, one of the first massage element and the second massage element is at least substantially spherical, and the other of the first massage element and the second massage element is at least substantially cylindrical. The first massage element and the second massage element may be maintained at a selected separation distance from one another during operative use of the massage device. In some examples, the massage device further comprises at least one separation adjustment mechanism for adjusting the selected separation distance. In some such examples, each separation adjustment mechanism is configured to be selectively transitioned between a use configuration, in which the separation adjustment mechanism at least partially restricts the selected separation distance from being selectively adjusted, and an adjustment configuration, in which the selected separation distance may be selectively adjusted. In such examples, when the at least one separation adjustment mechanism is in the use configuration, the separation adjustment mechanism restricts the selected separation distance from being increased. The massage device may be configured such that, during operative use of the massage device to massage the limb, the massage device is positioned such that the limb extends between the first massage element and the second massage element such that each of the first massage element and the second massage element engages the limb to exert a compressive force on the limb as the frame is translated relative to the limb.

Methods of utilizing a massage device to massage a limb of a user may include positioning a limb of a user between a first massage element and a second massage element of the massage device and applying a compressive force to the limb with each of the first massage element and the second massage element.

### BRIEF DESCRIPTION OF THE DRAWINGS

FIG. 1 is a schematic top plan view illustrating examples of massage devices according to the present disclosure.

FIG. 2 is a top side isometric view illustrating an example of a massage device during operative use of the massage device according to the present disclosure.

FIG. 3 is a top side isometric view illustrating an example of a support separation adjustment mechanism with a support receiver and a receiver notch according to the present disclosure.

FIG. 4 is a top side isometric view illustrating an example of a support separation adjustment mechanism with a support member collar and a collar lock mechanism according to the present disclosure.

FIG. 5 is a side elevation view illustrating an example of a frame separation adjustment mechanism utilizing a cam lock mechanism according to the present disclosure.

FIG. 6 is a side elevation view illustrating an example of a frame separation adjustment mechanism utilizing a ratchet mechanism according to the present disclosure.

FIG. 7 is a top perspective view illustrating an example of a massage device that includes a discretely adjustable support separation adjustment mechanism according to the present disclosure.

FIG. 8 is a top perspective view of the massage device of FIG. 7 with an increased selected separation distance according to the present disclosure

FIG. 9 is a semi-cross-sectional top plan view illustrating another example of a massage device that includes a continuously adjustable frame separation adjustment mechanism according to the present disclosure.

FIG. 10 is an end view illustrating the massage device of FIG. 9.

FIG. 11 is a semi-cross-sectional top plan view illustrating the massage device of FIGS. 9-10 with an increased selected separation distance according to the present disclosure.

FIG. 12 is a semi-cross-sectional top plan view illustrating another example of a massage device that includes a continuously adjustable frame separation adjustment mechanism according to the present disclosure.

FIG. 13 is a semi-cross-sectional top plan view illustrating the massage device of FIG. 12 with an increased selected separation distance according to the present disclosure.

FIG. 14 is a semi-cross-sectional top plan view illustrating another example of a massage device that includes a discretely adjustable frame separation adjustment mechanism according to the present disclosure.

FIG. 15 is a semi-cross-sectional top plan view illustrating the massage device of FIG. 14 with an increased selected separation distance.

FIG. 16 is a side view illustrating the massage device of FIGS. 14-15.

FIG. 17 is a semi-cross-sectional top plan view illustrating another example of a massage device that includes a continuously adjustable frame separation adjustment mechanism and a repositionable rotation support according to the present disclosure.

FIG. 18 is a semi-cross-sectional top plan view illustrating the massage device of FIG. 17 with an increased selected separation distance and with the repositionable rotation support adjusted, according to the present disclosure.

FIG. 19 is a flowchart depicting examples of methods of utilizing massage devices according to the present disclosure.

### DETAILED DESCRIPTION

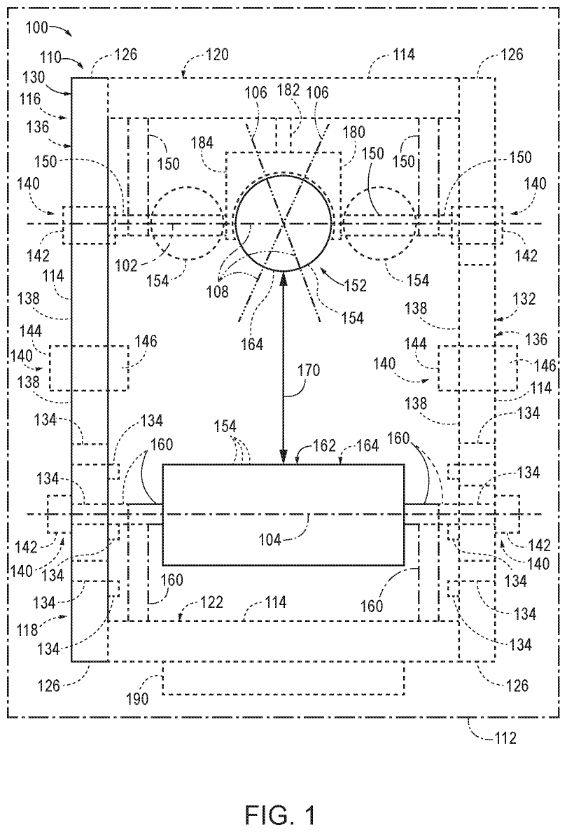

FIGS. 1-19 illustrate examples of massage devices 100 and/or of methods 200 of utilizing the massage devices, according to the present disclosure. Elements that serve a similar, or at least substantially similar, purpose are labeled with like numbers in each of FIGS. 1-19, and these elements may not be discussed in detail herein with reference to each of FIGS. 1-19. Similarly, all elements may not be labeled in each of FIGS. 1-19, but reference numbers associated therewith may be utilized herein for consistency. Elements, components, and/or features that are discussed herein with reference to one or more of FIGS. 1-19 may be included in and/or utilized with any of FIGS. 1-19 without departing from the scope of the present disclosure.

In general, elements that are likely to be included in a given (i.e., a particular) embodiment are illustrated in solid lines, while elements that are optional to a given embodiment are illustrated in dashed lines. However, elements that are shown in solid lines are not essential to all embodiments, and an element shown in solid lines may be omitted from a given embodiment without departing from the scope of the present disclosure.

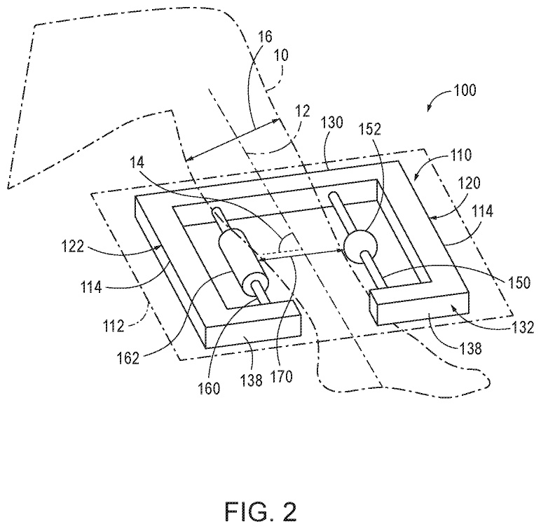

FIG. 1 is a schematic illustration of examples of massage devices 100. As discussed in more detail herein, massage device 100 is configured for massaging a limb of a user, such as an arm of the user, a leg of the user, and/or any suitable portion(s) thereof. More specifically, and as described in more detail herein, massage device 100 is configured to apply a compressive force to the limb while traversing a length of the limb, such as to alleviate pain, soreness, tension, etc. within the limb. As described in more detail herein, massage device 100 may be configured to enable the user to precisely control the magnitude of the compressive force applied to the limb and/or the precise location within the limb to which the compressive force is delivered. FIG. 2 is a depiction of an example of massage device 100 in operative use to massage a limb 10 in the form of a leg of the user. As used herein, limb 10 may refer to any appropriate portion of the body of the user to which a compressive force is applied by massage device 100. Accordingly, as used herein, limb 10 may include and/or be an arm, an upper arm, a forearm, a leg, a thigh, a shin, etc.

As used herein, descriptions of massage device 100 and/or components thereof contacting limb 10, engaging limb 10, rolling along limb 10, applying a compressive force to limb 10, etc. also may be understood as describing examples in which massage device 100 and/or components thereof contact an article of clothing and/or another covering of the limb in such a manner that the compressive force is delivered to the limb.

As used herein, massage device 100 may be described as being “in operative use” and/or as being “operatively utilized” when first massage element 152 and/or second massage element 162 engage limb 10 to apply a compressive force to the limb. In this manner, references within the present disclosure to massage device 100 (and/or a component thereof) in conjunction with limb 10 are intended to refer to a configuration in which massage device 100 operatively engages limb 10, such as a configuration in which limb 10 extends between first massage element 152 and second massage element 162. However, while the present disclosure generally describes examples in which massage device 100 operatively engages limb 10, such examples are not intended to be limiting.

As schematically illustrated in FIG. 1 and less schematically illustrated in FIG. 2, massage device 100 includes a frame 110, a first massage element 152 operatively supported by frame 110, and a second massage element 162 operatively supported by frame 110. More specifically, and as schematically illustrated in FIGS. 1-2, first massage element 152 is supported on a first support member 150, and second massage element 162 is supported on a second support member 160, with each of first support member 150 and second support member 160 being operatively coupled to frame 110. In this manner, first massage element 152 may be described as being operatively supported by frame 110 via first support member 150, and second massage element 162 may be described as being operatively supported by frame 110 via second support member 160.

As used herein, the terms “first,” “second,” and the like are utilized to differentiate between similar and/or analogous components and are not intended to imply a quality of relative priority, prominence, importance, etc. Accordingly, and as an example, references herein to a property and/or configuration of first massage element 152 also may be understood as applying to second massage element 162, and vice versa.

As illustrated in FIGS. 1-2, and as described in more detail herein, massage device 100 is configured such that first massage element 152 and second massage element 162 are spaced apart by a selected separation distance 170. Specifically, FIG. 1 schematically illustrates examples of massage device 100 in which first massage element 152 and second massage element 162 are spaced apart by selected separation distance 170, while FIG. 2 schematically illustrates an example of massage device 100 during operative use to massage limb 10 in the form of a leg of a user. FIG. 2 also may be described as schematically illustrating an example in which the user operates massage device 100 upon limb 10 with the user's hands, which are omitted from FIG. 2 for simplicity.

With reference to FIG. 2, selected separation distance 170 generally is selected to accommodate limb 10 of the user. Specifically, massage device 100 is configured such that selected separation distance 170 may be selectively sized to permit limb 10 to be inserted between first massage element 152 and second massage element 162 such that each of first massage element 152 and second massage element 162 exerts a compressive force on the limb, as described herein. For example, and as illustrated in FIG. 2, limb 10 may be characterized by a limb width 16, and selected separation distance 170 may be selected to correspond to limb width 16 of the portion of limb 10 to be massaged. As more specific examples, selected separation distance 170 may be selected to be slightly larger than limb width 16, slightly smaller than limb width 16, and/or at least substantially equal to limb width 16. Thus, while limb width 16 generally may vary across the length of a given limb 10, between distinct limbs 10 of a given user, and/or between respective limbs 10 of distinct users, massage device 100 may be configured and/or selectively adjusted such that selected separation distance 170 is sized to accommodate a given portion of a given limb 10 to be massaged. In this manner, and as described herein, massage device 100 may be selectively configured to massage limbs 10 of various sizes (e.g., of a given user and/or of a plurality of distinct users).

Moreover, massage device 100 may be configured to accommodate a variation in limb width 16 across a length of a given limb 10. Stated differently, massage device 100 may be configured such that each of first massage element 152 and second massage element 162 remains in rolling contact with limb 10 across an extent of the limb that exhibits a variation in limb width 16 during operative use of the massage device. As a more specific example, and as discussed herein, selectively tilting massage device 100 relative to limb 10 may enable limb 10 to be inserted between and remain in rolling contact with each of first massage element 152 and second massage element 162 while accommodating variation in limb width 16 along the limb 10. As another example, and as discussed herein, selectively tilting massage device 100 relative to limb 10 may enable the user to selectively regulate, modulate, and/or vary the magnitude of the compressive force that is applied to the limb.

Selected separation distance 170 may have any appropriate value, such as may correspond to limb width 16 of limb 10. As examples, during operative use of massage device 100, selected separation distance 170 may be at least 5 centimeters (cm), at least 10 cm, at least 15 cm, at least 20 cm, at least 25 cm, at least 30 cm, at least 40 cm, at most 50 cm, at most 45 cm, at most 35 cm, at most 27 cm, at most 22 cm, at most 17 cm, at most 12 cm, and/or at most 7 cm. Additionally or alternatively, during operative use of massage device 100, a ratio of selected separation distance 170 to limb width 16 of the portion of limb 10 to be massaged may be at least 0.8:1, at least 1:1, at least 1.2:1, at least 1.5:1, at least 2:1, at most 2.5:1, at most 1.7:1, at most 1.3:1, at most 1.1:1, and/or at most 0.9:1.

As described in more detail herein, selected separation distance 170 generally may be at least substantially fixed, constant, and/or otherwise restricted from changing during operative use of massage device 100 (e.g., while operating massage device 100 upon limb 10). However, and as discussed in more detail herein, during periods in which the massage device is not in operative use and/or is not applying a compressive force to the limb, the selected separation distance optionally may be selectively adjusted by the user, such as to accommodate the limb and/or to selectively vary the magnitude of the compressive force applied to the limb.

As described in more detail herein, massage device 100 generally is configured to permit the user to selectively adjust a degree and/or location of compressive force applied to limb 10 by first massage element 152 and/or second massage element 162, such as via selective variation of selected separation distance 170, selective reconfiguration of first massage element 152 and/or of second massage element 162, and/or selectively adjusting an angle of massage device 100 relative to limb 10. Additionally, massage device 100 may be configured such that first massage element 152 and second massage element 162 may move across limb 10 in any appropriate direction. In this manner, massage device 100 may enable the user to selectively target any desired location on limb 10 for receipt of the compressive force. As a more specific example, massage device 100 may be configured such that the magnitude and/or location of the compressive force may be selectively varied to precisely target trigger points, such as specific myofascial trigger points, to aid in breaking up muscle adhesions in the limb for myofascial release.

As described in more detail herein, massage device 100 is configured such that, during operative use of massage device 100 to massage limb 10, massage device 100 is positioned such that limb 10 extends between first massage element 152 and second massage element 162 and/or through frame 110 and such that each of first massage element 152 and second massage element 162 exerts a compressive force upon limb 10. More specifically, and as schematically illustrated in FIG. 2, massage device 100 and/or frame 110 may be described as extending within a device plane 112, while limb 10 may be described as extending along a limb axis 12 that extends through device plane 112 during operative use of massage device 100. Accordingly, as used herein, the term “compressive force,” as used to describe a force that is applied to limb 10, may refer generally to a force applied along a direction that is at least partially directed toward limb axis 12 and/or that is not parallel to limb axis 12. Stated differently, as used herein, the term “compressive force” may refer to a force applied along a direction that is at least partially parallel to device plane 112.

First support member 150 and/or second support member 160 may have any appropriate form and/or structure for supporting first massage element 152 and second massage element 162 relative to frame 110. For example, and as schematically illustrated in dashed lines in FIGS. 1-2, each of first support member 150 and second support member 160 may extend along a direction that is at least substantially straight and/or linear. In some such examples, and as schematically illustrated in dashed lines in FIGS. 1-2, first support member 150 and second support member 160 may extend parallel or at least substantially parallel, to one another. However, this is not required of all examples of massage device 100, and it is within the scope of the present disclosure that first support member 150 and second support member 160 may be operatively coupled to frame 110 in any appropriate manner and in any appropriate configuration. For example, and as schematically illustrated in dashed lines and in dash-dot lines in FIG. 1, each of first support member 150 and/or second support member 160 may include distinct portions and/or segments that extend along respective directions that are not parallel to one another. While FIGS. 1-2 schematically illustrate first support member 150 and second support member 160 as being at least substantially straight, and/or as being formed of components that are at least substantially straight, this is not required of all examples of massage device 100. For example, it is additionally within the scope of the present disclosure that first support member 150 and/or second support member 160 may be at least partially curved.

In some examples, first support member 150 and/or second support member 160 may be at least substantially rigid, such as to maintain first massage element 152 and/or second massage element 162 at a location that is fixed, or at least substantially fixed, relative to frame 110. In other examples, and as described herein, first support member 150 and/or second support member 160 may be resilient, flexible, and/or deformable, such as to enable first massage element 152 and/or second massage element 162 to move relative to frame 110 during operative use of massage device 100. As used herein, first support member 150, first massage element 152, second support member 160, and/or second massage element 162 may be described as being positioned at a location that is at least substantially fixed relative to frame 110 even when the component is configured to rotate (e.g., rotate in place about an axis or axle) relative to frame 110.

In some examples, and as discussed, each of first massage element 152 and second massage element 162 is configured to rotate relative to frame 110. As a more specific example, and as schematically illustrated in FIG. 1, first massage element 152 may be configured to rotate relative to frame 110 about a first axis of rotation 102, and second massage element 162 may be configured to rotate relative to frame 110 about a second axis of rotation 104. As schematically illustrated in FIG. 1, first axis of rotation 102 and second axis of rotation 104 may be parallel or at least substantially parallel to one another. However, this is not required of all examples of massage device 100 in all cases, and it is additionally within the scope of the present disclosure that first axis of rotation 102 and second axis of rotation 104 may be tilted and/or angled with respect to one another. In some examples, and as further schematically illustrated in FIGS. 1-2, first axis of rotation 102 and/or second axis of rotation 104 each may extend within device plane 112. In an example in which first axis of rotation 102 is at least substantially parallel to second axis of rotation 104, first axis of rotation 102 and second axis of rotation 104 together may be described as defining device plane 112. However, this is not required to all massage devices 100, and it is additionally within the scope of the present disclosure that first axis of rotation 102 and/or second axis of rotation 104 may be non-parallel with device plane 112 and/or may intersect device plane 112.

Each massage element (i.e., first massage element 152 or second massage element 162) may be supported by the corresponding support member (i.e., first support member 150 or second support member 160) in any appropriate manner. For example, first support member 150 and/or second support member 160 may be fixedly coupled to the frame, such as in a manner that restricts the support member from translating and/or rotating relative to the frame. In such examples, first massage element 152 and/or second massage element 162 may be configured to rotate relative to the respective support member. As a more specific example, first support member 150 may be fixedly (e.g., non-rotatably) coupled to frame 110, and first massage element 152 may be configured to rotate about first axis of rotation 102 relative to first support member 150. Similarly, second support member 160 may be fixedly (e.g., non-rotatably) coupled to frame 110, and second massage element 162 may be configured to rotate relative to second support member 160.

In other examples, first support member 150 and/or second support member 160 may be configured to rotate relative to frame 110. For example, first support member 150 may be configured to rotate relative to frame 110 about first axis of rotation 102. In such an example, first massage element 152 may be fixedly (e.g., non-rotatably) coupled to first support member 150 such that rotating first support member 150 relative to frame 110 operates to rotate first massage element 152 relative to frame 110. Alternatively, in an example in which first support member 150 is configured to rotate relative to frame 110, first massage element 152 also may be configured to rotate relative to first support member 150. As another example, second support member 160 may be configured to rotate relative to frame 110 about second axis of rotation 104. In such an example, second massage element 162 may be fixedly (e.g., non-rotatably) coupled to second support member 160 such that rotating second support member 160 relative to frame 110 operates to rotate second massage element 162 relative to frame 110. Alternatively, in an example in which second support member 160 is configured to rotate relative to frame 110, second massage element 162 also may be configured to rotate relative to first support member 150.

In some examples, and as described herein, massage device 100 is configured such that each of first massage element 152 and second massage element 162 engages limb 10 of the user at least substantially without slipping as frame 110 is translated relative to the limb (or vice versa) during operative use of the massage device. That is, in such examples, each of first massage element 152 and second massage element 162 is configured to rotate relative to frame 110 as the limb passes between and in contact with each of first massage element 152 and second massage element 162 in such a manner that an outer surface of each massage element remains in at least substantially static contact with the limb while applying a compressive force to the limb. Stated differently, in such examples, each of first massage element 152 and second massage element 162 is configured to roll along limb 10 without slipping relative to the limb. In this manner, first massage element 152 and second massage element 162 may be configured to apply a compressive force to limb 10 without additionally exerting a shear force on the limb, enabling the user to massage the limb comfortably and effectively.

In some examples, and as schematically illustrated in FIG. 1, first massage element 152 and/or second massage element 162 may be a multi-axis massage element 164 that is configured to rotate relative to frame 110 about more than one rotational axis defined relative to frame 110. Specifically, FIG. 1 schematically illustrates an example in which first massage element 152 (and/or a massage component 154 thereof) is a multi-axis massage element 164 that is configured to rotate relative to frame 110 about a plurality of distinct axes of rotation, such as may include first axis of rotation 102 and/or one or more tilted axes of rotation 106 that are nonparallel with one or both of first axis of rotation 102 and second axis of rotation 104. More specifically, and as schematically illustrated in FIG. 1, multi-axis massage element 164 may be described as rotating relative to frame 110 about a variable axis of rotation 108, such as may be first axis of rotation 102, second axis of rotation 104, and/or one or more tilted axes of rotation 106, such that an orientation of variable axis of rotation 108 relative to frame 110 may be varied and/or adjusted. As examples, and as discussed in more detail below, the orientation of variable axis of rotation 108 relative to frame 110 may be at least substantially fixed during operative use of massage device 100, or variable axis of rotation 108 may refer to an instantaneous axis of rotation of an example of multi-axis massage element 164 that rotates with multiple degrees of rotational freedom. Utilizing one or more multi-axis massage elements 164 in massage device 100 may enable massage device 100 to be rotated relative to limb 10 of the user while maintaining multi-axis massage element 164 in non-slipping engagement with the limb.

In some examples, multi-axis massage element 164 may be configured to rotate about any of a finite plurality of distinct axes of rotation. Stated differently, in such examples, multi-axis massage element 164 may be configured such that variable axis of rotation 108 may assume one of a discrete plurality of orientations relative to frame 110 during operative use of massage device 100. As an example, and as schematically illustrated in FIG. 1, first support member 150 and/or second support member 160 may include and/or be a repositionable rotation support 180 (such as schematically illustrated in conjunction with first support member 150 in FIG. 1) that supports multi-axis massage element 164 and that is configured to selectively reposition and/or reorient multi-axis massage element 164 and/or variable axis of rotation 108 relative to frame 110. In this manner, repositionable rotation support 180 may be configured to selectively adjust an orientation of variable axis of rotation 108 relative to frame 110 and/or device plane 112.

In an example in which multi-axis massage element 164 is supported by repositionable rotation support 180, multi-axis massage element 164 may be configured to rotate relative to frame 110 with one degree of rotational freedom during operative use of massage device 100 about a rotational axis (i.e., variable axis of rotation 108) that may be selectively adjusted. For example, repositionable rotation support 180 may be configured to be selectively repositioned and/or rotated relative to frame 110 to adjust an orientation of variable axis of rotation 108 relative to frame 110. As more specific examples, repositionable rotation support 180 may be configured to selectively rotate multi-axis massage element 164 (and hence variable axis of rotation 108) relative to frame 110 in discrete angular increments, such as 30-degree increments, 45-degree increments, 60-degree increments, and/or 90-degree increments, such as while massage device 100 is not in operative use. In other examples, repositionable rotation support 180 may be continuously adjustable to selectively rotate multi-axis massage element 164 (and hence variable axis of rotation 108) relative to frame 110 to any orientation within a continuous range of motion of repositionable rotation support 180. Stated differently, in such examples, repositionable rotation support 180 may enable variable axis of rotation 108 to be continuously adjustable within the range of motion of the repositionable rotation support.

Repositionable rotation support 180 may be configured to selectively reposition multi-axis massage element 164 relative to frame 110 when massage device 100 is not in operative use and/or when limb 10 is removed from frame 110. As a more specific example, and as schematically illustrated in FIG. 1 and described in more detail herein, repositionable rotation support 180 may include a repositioning mechanism 182 that is configured to be selectively activated, actuated, and/or otherwise manipulated by a user to selectively adjust repositionable rotation support 180. In some examples, repositioning mechanism 182 biases repositionable rotation support 180 toward a configuration in which variable axis of rotation 108 is at least substantially fixed relative to frame 110. In such examples, repositionable rotation support 180 may be configured to be manipulated by a user to selectively adjust variable axis of rotation 108 by overcoming the biasing force of repositioning mechanism 182, such as by pulling against a spring force exerted by repositioning mechanism 182. Repositioning mechanism 182 may include and/or be any appropriate structure for permitting selective variation of variable axis of rotation 108, such as a spring-biased mechanism and/or a locking mechanism.

As discussed, a massage element (e.g., first massage element 152 or second massage element 162) still may be referred to as a multi-axis massage element even when the massage element rotates relative to frame 110 about a single axis of rotation during operative use of massage device 100 and until variable axis of rotation 108 is selectively adjusted and/or modified with repositionable rotation support 180.

In other examples, multi-axis massage element 164 may be configured to rotate about any of a continuous plurality (e.g., an infinite continuum) of variable axes of rotation 108. For example, multi-axis massage element 164 may be configured to rotate freely relative to frame 110 with three degrees of rotational freedom, and thus may be free to rotate relative to frame 110 about any axis of rotation. In such examples, variable axis of rotation 108 may refer to an axis about which multi-axis massage element 164 rotates at a given moment and/or instant in time. That is, in such examples, variable axis of rotation 108 may be unconstrained and/or continually variable relative to frame 110, but a rotational direction of multi-axis massage element 164 still may be described in terms of a particular orientation of variable axis of rotation 108 at any given (i.e., particular) moment in time during operative use of massage device 100. In such examples, multi-axis massage element 164 may be supported in any appropriate manner. For example, and as schematically illustrated in FIG. 1, first support member 150 and/or second support member 160 may include and/or be a universal rotation support 184 (such as schematically illustrated in conjunction with first support member 150 in FIG. 1) that is configured to enable multi-axis massage element 164 to rotate relative to frame 110 with more than one degree of rotational freedom, such as with three degrees of rotational freedom. Universal rotation support 184 may include and/or be any appropriate structure and/or mechanism, examples of which include a ball joint, a spherical rolling joint, and/or a universal joint.

Each of first massage element 152 and second massage element 162 may have any appropriate shape, structure, functionality, and/or configuration for applying a compressive force to limb 10. As examples, one or both of first massage element 152 and second massage element 162 may have a shape that is spherical, ellipsoidal, conical, and/or cylindrical. In some examples, first massage element 152 has a shape that is different than a shape of second massage element 162. In such examples, first massage element 152 and second massage element 162 may be configured to apply the compressive force to limb 10 across distinct respective regions and/or with distinct respective local magnitudes. As a more specific example, first massage element 152 may be shaped, sized, and/or otherwise configured to contact a smaller surface area of limb 10 relative to second massage element 162 during operative use of massage device 100, such that first massage element 152 delivers a more localized compressive force to limb 10 relative to second massage element 162.

As a more specific example, FIGS. 1-2 schematically illustrate an example in which first massage element 152 is at least substantially spherical and in which second massage element 162 is at least substantially cylindrical. Thus, during operative use of the example massage device 100 of FIGS. 1-2, first massage element 152 may apply a compressive force to a smaller region of limb 10, and/or with a greater localized force magnitude, relative to second massage element 162. In such examples, second massage element 162 may be described as supporting massage device 100 relative to limb 10 of the user while first massage element 152 exerts a more localized compressive force on the limb, thereby enabling the user to precisely focus the magnitude and/or location of the massage force as desired. However, this is not required of all examples of massage device 100, and it is additionally within the scope of the present disclosure that second massage element 162 may be at least substantially spherical and that first massage element 152 may be at least substantially cylindrical, such that second massage element 162 exerts the more localized compressive force on the limb during operative use of massage device 100.

First massage element 152 and second massage element 162 each may be formed of any appropriate respective materials. As examples, each of first massage element 152 and second massage element 162 may be formed of a plastic, a rubber, a foam, a metal, a wood, and/or combinations thereof. In some examples, first massage element 152 and second massage element 162 are formed of different materials. As a more specific example, first massage element 152 may be a rubber ball, while second massage element 162 may be a foam cylinder. Additionally or alternatively, first massage element 152 and second massage element 162 may be configured to exhibit distinct material properties. As a more specific example, one of first massage element 152 and second massage element 162 may be more compressible, may have a lower elastic modulus, and/or may be softer than the other of first massage element 152 and second massage element 162.

In some examples, and as schematically illustrated in FIG. 1, first massage element 152 and/or second massage element 162 may include a plurality of distinct massage components 154, each of which is configured to engage limb 10 during operative use of massage device 100. Specifically, FIG. 1 schematically illustrates an example in which first massage element 152 includes a plurality of distinct massage components 154 in the form of a plurality of spheres supported by first support member 150. It also is within the scope of the present disclosure that second massage element 162 additionally or alternatively may include a plurality of distinct massage components 154. In an example in which first massage element 152 does not include a plurality of distinct massage components 154, first massage element 152 instead may be described as including a single massage component 154. Similarly, in an example in which second massage element 162 does not include a plurality of distinct massage components 154, second massage element 162 instead may be described as including a single massage component 154.

In an example in which first massage element 152 and/or second massage element 162 includes a plurality of distinct massage components 154, each of the plurality of massage components 154 may be configured to engage limb 10 concurrently during operative use of massage device 100. For example, the plurality of massage components 154 of first massage element 152 and/or of second massage element 162 may be shaped, sized, positioned, and/or otherwise configured such that each massage component 154 engages limb 10 during operative use of massage device 100. Additionally or alternatively, the plurality of massage components 154 may be supported by first support member 150 or by second support member 160 that is shaped (e.g., curved) to position the plurality of massage components 154 in such a manner that each massage component 154 engages limb 10 during operative use of massage device 100. Additionally or alternatively, the plurality of massage components 154 may be supported by first support member 150 or by second support member 160 that is flexible and/or deformable to bring each massage component 154 into engagement with limb 10 during operative use of massage device 100.

In some examples, the plurality of massage components 154 may be configured to rotate with respect to frame 110 and with respect to one another. That is, in such examples, each of one or more massage components 154 may be configured to rotate with respect to at least one other massage component 154. In other examples, the plurality of massage components 154 may be configured to rotate with respect to frame 110 at least substantially in unison.

As used herein, when discussing an example of a massage element (i.e., first massage element 152 and/or second massage element 162) that includes one or more distinct massage components 154, a description of structural and/or functional characteristics of the massage element may be understood as describing the massage element as a whole and/or as describing each corresponding massage component 154 thereof. Similarly, descriptions herein of structural and/or functional characteristics of one or more massage components 154 also may be understood as describing each of the one or more massage components 154 and/or as describing the massage element (i.e., first massage element 152 or second massage element 162) that includes the massage components 154. Thus, while the examples and descriptions herein generally relate to examples in which each of first massage element 152 and second massage element 162 includes a single respective massage component 154, it is to be understood that these descriptions also may relate to examples in which first massage element 152 and/or second massage element 162 includes a plurality of distinct massage components 154.

In some examples, massage device 100 may be configured to permit and/or facilitate selective removal and replacement of one or more of first support member 150, first massage element 152, second support member 160, and second massage element 162. For example, and as discussed in more detail herein, one or both of first support member 150 and second support member 160 may be configured to be selectively uncoupled from frame 110. In some such examples, first massage element 152 (and/or second massage element 162) may be configured to be selectively removed from first support member 150 (and/or second support member 160), such as to replace the massage element with a massage element of a different shape or material property. Additionally or alternatively, first support member 150 and/or second support member 160 may be configured to be selectively removed from frame 110 and replaced with a different support member, such as a support member including a massage element (e.g., first massage element 152 or second massage element 162) of a different shape or material property than that of the support member that is removed. As used herein, references to selective removal or uncoupling of the first or second massage elements or other components of the massage device refer to removal or uncoupling without damage or destruction of the massage element(s) or other components of the massage device or of the remainder of the massage device.

With continued reference to FIG. 1, frame 110 may have any appropriate structure and/or form for supporting first support member 150 and second support member 160. For example, and as schematically illustrated in FIG. 1, frame 110 may include a first frame side 130, a second frame side 132 that is spaced apart from first frame side 130, a first frame end 120 that extends from first frame side 130, and/or a second frame end 122 that is spaced apart from first frame end 120 and that extends from first frame side 130 and/or from second frame side 132. For example, when present, each of first frame end 120 and/or second frame end 122 may be fixedly coupled to first frame side 130 and/or to second frame side 132.

While FIG. 1 schematically illustrates first frame end 120, second frame end 122, first frame side 130, and second frame side 132 as being distinct components that are operatively coupled to one another to form frame 110, this is not required of all examples of frame 110. For example, two or more of first frame end 120, second frame end 122, frst frame side 130, and second frame side 132, may refer to and/or correspond to respective portions, regions, and/or segments of a unitary structure that forms at least a portion of frame 110. In such examples, two or more of first frame end 120, second frame end 122, first frame side 130, and second frame side 132 may be described as being integrally formed with one another. As a more specific example, and as schematically illustrated in FIG. 1, frame 110 may include one or more frame transition regions 126 that join two of first frame end 120, second frame end 122, first frame side 130, and second frame side 132 to one another such that each frame transition region 126 is integrally formed with the portions of frame 110 that it interconnects. In some examples, each frame transition region 126 may be at least partially curved, such as to operatively couple two portions of frame 110 that are at least substantially straight to one another.

As used herein, a portion of frame 110 and/or two or more regions thereof may be described as being “unitary” when the portion and/or regions are integrally formed, continuously formed, co-molded, monolithic, and/or otherwise materially uniform. Accordingly, as an example, frame 110 may be configured such that first frame side 130 is integrally formed with first frame end 120, optionally via frame transition region 126, even when first frame side 130 itself includes distinct components that are not integrally formed with one another.

As schematically illustrated in FIG. 1, each of first frame side 130, second frame side 132, first frame end 120, and/or second frame end 122 may be at least substantially straight. However, this is not required of all examples of frame 110, and it is additionally within the scope of the present disclosure that first frame side 130, second frame side 132, first frame end 120, and/or second frame end 122 may be at least partially or even completely curved. For example, and as discussed, in an example in which two or more of first frame end 120, second frame end 122, first frame side 130, and second frame side 132 are integrally formed with one another, frame 110 may include one or more curved and/or arcuate frame transition regions 126 that operatively join such components to one another.

In some examples, and as additionally schematically illustrated in FIG. 1, first frame side 130 and second frame side 132 may extend at least substantially parallel to one another, and/or first frame end 120 and second frame end 122 may extend at least substantially parallel to one another. Additionally or alternatively, first frame side 130, second frame side 132, first frame end 120, and/or second frame end 122 may extend within, and/or at least substantially parallel to, device plane 112. Additionally or alternatively, first support member 150 and/or second support member 160 may extend at least substantially parallel to first frame end 120 and/or second frame end 122.

First support member 150 and second support member 160 each may be coupled to any appropriate portions and/or components of frame 110. As examples, and as schematically illustrated in dashed lines in FIG. 1, each of first support member 150 and/or second support member 160 may extend from and/or be operatively coupled to first frame side 130 and/or second frame side 132. Additionally or alternatively, and as schematically illustrated in dash-dot lines in FIG. 1, each of first support member 150 and/or second support member 160 may extend from and/or be operatively coupled to first frame end 120 and/or to second frame end 122.

While FIG. 1 schematically illustrates each of first frame side 130, second frame side 132, first frame end 120, and second frame end 122 as being continuous in extent, this is not required of all examples of frame 110. For example, and as schematically illustrated in FIG. 1, one or more of first frame side 130, second frame side 132, first frame end 120, and second frame end 122 may include and/or consist of a respective plurality of distinct frame side segments 138. As a more specific example, the respective frame side segments 138 of a portion of frame 110 (e.g., of first frame side 130, of second frame side 132, of first frame end 120, or of second frame end 122) may be disconnected and/or spaced apart from one another. For example, FIGS. 1-2 illustrate examples in which second frame side 132 includes a pair of disconnected frame side segments 138, such that each of first support member 150 and second support member 160 extends from first frame side 130 and one of the pair of frame side segments 138. Thus, in such a configuration, frame 110 may be at least substantially C-shaped, such as to enable massage device 100 to be positioned around limb 10 without necessitating inserting an end of the limb into frame 110. In other examples, frame 110 may omit and/or not include one or more of first frame side 130, second frame side 132, first frame end 120, and second frame end 122, such that frame 110 similarly includes an “open” side to facilitate placement of massage device 100 relative to limb 10.

In some examples, and as discussed in more detail below, frame side segments 138 of a portion of frame 110 (e.g., of first frame side 130 and/or of second frame side 132) may be operatively connected to one another and configured to facilitate selective variation of selected separation distance 170. As a more specific example, and as schematically illustrated in FIG. 1, each of first frame side 130 and second frame side 132 may include a respective plurality of frame side segments 138, including a first (upper) frame side segment and a second (lower) frame side segment. In such examples, and as schematically illustrated in FIG. 1, frame 110 may include a first frame portion 116 that includes the first (upper) frame side segment 138 of first frame side 130, first frame end 120, and the first (upper) frame side segment 138 of second frame side 132 fixedly coupled to one another. Similarly, in such examples, frame 110 may include a second frame portion 118 that includes the second (lower) frame side segment 138 of first frame side 130, second frame end 122, and the second (lower) frame side segment 138 of second frame side 132 fixedly coupled to one another. In this manner, and as schematically illustrated in FIG. 1, first massage element 152 may be operatively supported by first frame portion 116, and second massage element 162 may be operatively supported by second frame portion 118, such that selected separation distance 170 may be adjusted via selective adjustment of first frame portion 116 relative to second frame portion 118, as discussed herein.

As used herein, positional terms such as “upper,” “lower,” “left-hand.” “right-hand.” and the like generally refer to orientations and/or configurations as depicted in the figures. Thus, such terms are not limiting, and are provided only to facilitate interpretation of the figures, and/or to facilitate an understanding of aspects and components of massage device 100 in view of the figures. Such positional descriptors do not require that massage device 100 always be in a position and/or orientation as depicted in the figures.

As discussed, massage device 100 generally is configured to be manipulated by a user to massage a limb. Specifically, frame 110 generally is configured to be gripped by a user during operative use of massage device 100. In some examples, and as schematically illustrated in FIGS. 1-2, one or more of first frame side 130, second frame side 132, first frame end 120, second frame end 122, and/or frame transition region(s) 126 may include a grip feature 114 that is configured to be gripped by the user, such as by one or both of the user's hands, to translate and/or rotate massage device 100 relative to limb 10 during operative use of massage device 100. In such examples, grip feature 114 may include and/or be any appropriate structure to facilitate holding massage device 100 and/or frame 110, examples of which include a handle, a grip, and/or a textured surface that is configured to be gripped by the user during operative use of massage device 100. For example, grip feature 114 may be configured to enable the user to grip massage device 100 with one or both of the user's hands without interfering with the operation and/or rotation of first massage element 152 and/or second massage element 162. In some examples, grip feature 114 may be sized to have a length, or dimension that is longer than the width of the user's hand, thereby facilitating firm and comfortable gripping of the region during operative use of massage device 10.

Frame 110 may be formed of any suitable material or materials and may have any appropriate form or structure. As examples, frame 110 and/or any portion thereof, including first frame side 130, second frame side 132, first frame end 120, second frame end 122, and/or one or more frame transition regions 126 may be formed of a wood, a plastic, a metal, and/or combinations thereof. An example of a suitable metal is aluminum, although others may be used. As additional examples, frame 110 and/or any portion thereof, including first frame side 130, second frame side 132, first frame end 120, second frame end 122, and/or one or more frame transition regions 126 may have a cross-sectional profile that is circular, elliptical, rectangular, square, polygonal, and/or any suitable combination thereof.

Turning now to FIG. 2, FIG. 2 schematically illustrates an example of massage device 100 being utilized to massage limb 10 in the form of a leg of the user. As schematically illustrated in FIG. 2, and as discussed, limb 10 may be characterized by limb axis 12 along which the limb extends, and massage device 100 may be configured such that limb axis 12 intersects and/or extends through device plane 112 during operative use of massage device 100. In this manner, limb axis 12 may be described as being non-parallel to, and/or as being at least partially perpendicular to, device plane 112 during operative use of massage device 100. More specifically, and as further schematically illustrated in FIG. 2, operative use of massage device 100 may be characterized in terms of a limb angle 14 as measured between limb axis 12 and device plane 112. In some examples, massage device 100 may be configured such that, during operative use of massage device 100, limb 10 extends relative to frame 110 at limb angle 14 that is at least 30 degrees, at least 45 degrees, at least 60 degrees, at least 75 degrees, at most 90 degrees, at most 80 degrees, at most 65 degrees, at most 50 degrees, and/or at most 35 degrees. In some examples, and as illustrated in FIG. 2, limb angle 14 represents a smallest angle between limb axis 12 and device plane 112, such that limb angle 14 is a non-negative quantity that is at most 90 degrees.

In some examples, massage device 100 is configured to enable the user to selectively adjust limb angle 14 during operative use of massage device 100. For example, and as discussed, first frame end 120 and/or second frame end 122 (and/or grip feature 114 thereof) may be configured to be gripped by the user to selectively tilt frame 110 relative to limb 10 to adjust limb angle 14 during operative use of massage device 100. As more specific examples, the user may tilt frame 110 to decrease limb angle 14 in order to increase the compressive force exerted upon limb 10, or may tilt frame 110 to increase limb angle 14 in order to decrease the compressive force exerted upon limb 10. In this manner, in an example in which first massage element 152 is at least substantially spherical and in which second massage element 162 is at least substantially cylindrical, the user may tilt frame 110 relative to limb 10 in such a manner that the second massage element acts as a fulcrum for urging the first massage element against the limb. Thus, in such an example, the mechanical advantage of leverage may be utilized to precisely control the magnitude and/or location of the compressive force exerted by the first massage element upon the limb. Additionally or alternatively, tilting frame 110 to decrease limb angle 14 may enable first massage element 152 and second massage element 162 to remain in contact with limb 10, such as with a compressive force magnitude that is at least substantially constant, as limb width 16 decreases over the length of a given limb 10. Similarly, tilting frame 110 to increase limb angle 14 may enable first massage element 152 and second massage element 162 to remain in contact with limb 10, such as with a compressive force magnitude that is at least substantially constant, as limb width 16 increases over the length of a given limb 10.

As discussed, massage device 100 is configured to enable selective adjustment of selected separation distance 170 between first massage element 152 and second massage element 162. In some examples, and as described herein, massage device 100 generally is configured to enable selected separation distance 170 to be selectively adjusted in such a manner that massage device 100 is disabled from being operatively utilized to massage limb 10 while selected separation distance 170 is being selectively adjusted and/or while massage device 100 is in a configuration that permits selective adjustment of selected separation distance 170. In some other examples, and as discussed herein, massage device 100 is configured such that selected separation distance 170 is at least partially restricted from being selectively adjusted during operative use of massage device 100.

As schematically illustrated in FIG. 1, massage device 100 may include at least one separation adjustment mechanism 140 for adjusting selected separation distance 170. Each separation adjustment mechanism 140 may be configured to enable selective adjustment of selected separation distance 170 in any appropriate manner. For example, and as schematically illustrated in FIG. 1, a given (e.g., a particular) separation adjustment mechanism 140 may include and/or be a support separation adjustment mechanism 142 that enables one or both of first support member 150 and second support member 160 to be selectively adjusted and/or repositioned relative to frame 110 and/or relative to one another to adjust selected separation distance 170. Additionally or alternatively, and as schematically illustrated in FIG. 1, a given (e.g., a particular) separation adjustment mechanism 140 may include and/or be a frame separation adjustment mechanism 144 that enables adjustment of selected separation distance 170 via a selective reconfiguration of frame 110. More specifically, and as described in more detail below, frame separation adjustment mechanism 144 may be configured to permit adjustment of selected separation distance 170 via selective adjustment and/or repositioning of one or more of first frame side 130, second frame side 132, first frame end 120, and second frame end 122, such as to reposition one or more components of frame 110 relative to one another. As a more specific example, and as described in more detail below, frame separation adjustment mechanism 144 may be configured to selectively permit and/or restrict relative motion between first frame portion 116 and second frame portion 118 to enable selective adjustment of selected separation distance 170.

As used herein, references to examples of massage device 100 that include multiple separation adjustment mechanisms 140 (e.g., one or more support separation adjustment mechanisms 142 and/or one or more frame separation adjustment mechanisms 144) may be described in terms of aspects, properties, configurations, etc. of separation adjustment mechanism 140. In such examples, a description of an aspect, property, configuration, etc. of separation adjustment mechanism 140 may be understood as referring to any suitable separation adjustment mechanism(s) of the plurality of separation adjustment mechanisms, such as a single separation adjustment mechanism, a subset of the plurality of separation adjustment mechanisms, and/or each of the separation adjustment mechanisms. In this manner, as used herein, the term “separation adjustment mechanism 140” may be understood as being equivalent to the phrase “each separation adjustment mechanism 140 of the one or more separation adjustment mechanisms 140.”

As discussed herein, separation adjustment mechanism 140 (e.g., each support separation adjustment mechanism 142 and/or each frame separation adjustment mechanism 144) generally is configured to be selectively transitioned between a use configuration and an adjustment configuration. Specifically, when separation adjustment mechanism 140 is in the use configuration, separation adjustment mechanism 140 at least partially restricts selected separation distance 170 from being selectively adjusted. As more specific examples, when separation adjustment mechanism 140 is in the use configuration, selected separation distance 170 may be at least substantially fixed, constant, and/or restricted from increasing, such that massage device 100 may be operatively utilized to massage limb 10. When separation adjustment mechanism 140 is in the adjustment configuration, selected separation distance 170 may be adjusted (e.g., increased and/or decreased), such as to configure and/or customize massage device 100 for the limb 10 to be massaged.

In this manner, as used herein, massage device 100 may be described as being configured to be operatively utilized when separation adjustment mechanism 140 is in the use configuration such that the respective positions of first massage element 152 and second massage element 162 are sufficiently fixed relative to one another to collectively apply a compressive force to limb 10. However, it is additionally within the scope of the present disclosure that separation adjustment mechanism 140 may be transitioned between the use configuration and the adjustment configuration while one or both of first massage element 152 and second massage element 162 engages limb 10 and/or while limb 10 is received between first massage element 152 and second massage element 162. In this manner, separation adjustment mechanism 140 may be configured such that selected separation distance 170 may be adjusted without removing limb 10 from massage device 100. As used herein, massage device 100 also may be described as being in the use configuration when separation adjustment mechanism 140 is in the use configuration, and/or massage device 100 also may be described as being in the adjustment configuration when separation adjustment mechanism 140 is in the adjustment configuration.

In some examples, and as schematically illustrated in FIG. 1, separation adjustment mechanism 140 (e.g., support separation adjustment mechanism 142, frame separation adjustment mechanism 144, and/or any component thereof) includes an adjustment mechanism actuator 146. When present, and as described herein, adjustment mechanism actuator 146 is configured to be selectively manipulated by a user to transition separation adjustment mechanism 140 between the use configuration and the adjustment configuration.

In an example in which massage device 100 includes a plurality of separation adjustment mechanisms 140 (e.g., one or more support separation adjustment mechanisms 142 and/or one or more frame separation adjustment mechanisms 144), each separation adjustment mechanism 140 may be selectively independently transitioned between the use configuration and the adjustment configuration. In such examples, massage device 100 may be configured such that selected separation distance 170 may be varied (e.g., increased and/or decreased) when any (e.g., at least one) of the plurality of separation adjustment mechanisms 140 is in the adjustment configuration. Similarly, in such examples, massage device 100 may be configured such that selected separation distance 170 is at least partially restricted from being selectively adjusted only when each of the plurality of separation adjustment mechanisms 140 is in the use configuration.

In some examples, massage device 100 is disabled from being operatively utilized to massage limb 10 when separation adjustment mechanism 140 is in the adjustment configuration. Stated differently, when separation adjustment mechanism 140 is in the adjustment configuration, selected separation distance 170 may be adjustable, freely adjustable, and/or otherwise less constrained relative to the use configuration such that first massage element 152 and second massage element 162 are less capable of applying a therapeutic compressive force to limb 10 relative to when separation adjustment mechanism 140 is in the use configuration. Stated another way, massage device 100 may be configured such that selected separation distance 170 may be operatively adjusted and/or increased only when separation adjustment mechanism 140 is in the adjustment configuration.

As used herein, the term “operatively,” as used to describe an adjustment of selected separation distance 170, is intended to refer to a condition and/or configuration of massage device 100 and/or of separation adjustment mechanism 140 in which selected separation distance 170 may be selectively adjusted as described herein, e.g., without damage to massage device 100.

In some examples, and as described herein, separation adjustment mechanism 140 may be configured to restrict adjustment of selected separation distance 170 in one direction, but to permit selective adjustment of selected separation distance 170 in another direction, while in the use configuration. As an example, and as described in more detail herein, separation adjustment mechanism 140 may be configured to permit selected separation distance 170 from being decreased and to restrict selected separation distance 170 to be increased while separation adjustment mechanism 140 remains in the use configuration.

In some examples, and as discussed, massage device 100 includes a plurality of separation adjustment mechanisms 140, such as one or more support separation adjustment mechanisms 142 and/or one or more frame separation adjustment mechanisms 144. Thus, in such examples, a configuration of massage device 100 may be fine-tuned for the dimensions or compressive force needs of a selected limb 10. For example, support separation adjustment mechanism 142 may permit a relatively coarse-scale adjustment of selected separation distance 170, while frame separation adjustment mechanism 144 may permit a relatively fine-scale adjustment of selected separation distance 170 (or vice-versa). In all examples in which massage device 100 includes a plurality of separation adjustment mechanisms 140, descriptions herein of separation adjustment mechanism 140 being in the use configuration or the adjustment configuration may refer to any one of the plurality of separation adjustment mechanisms, to any subset of the plurality of separation adjustment mechanisms, and/or to each (i.e., all) of the plurality of separation adjustment mechanisms.

As discussed, massage device 100 generally is configured such that selected separation distance 170 is at least substantially fixed and/or constant when separation adjustment mechanism 140 is in the use configuration. That is, when separation adjustment mechanism 140 is in the use configuration, a position of first massage element 152 relative to second massage element 162, and hence selected separation distance 170, is at least substantially constant (at least when limb 10 is removed from massage device 100), even in an example in which first massage element 152 and/or second massage element 162 is formed of a material that is deformable and/or compressible.

Separation adjustment mechanism 140 may be configured to enable adjustment of selected separation distance 170 in any appropriate manner. As an example, separation adjustment mechanism 140 may be configured to permit selected separation distance 170 to be continuously adjustable, such as within a range of distances and/or between maximum and minimum separation distances 170. Stated differently, in such examples, separation adjustment mechanism 140 may be configured such that, when separation adjustment mechanism 140 is in the adjustment configuration, selected separation distance 170 may be adjustable through a continuum of selected separation distances 170. As another example, separation adjustment mechanism 140 may be configured to permit selected separation distance 170 to be discretely adjustable. Stated differently, in such examples, when separation adjustment mechanism 140 is in the adjustment configuration, selected separation distance 170 may be adjustable in discrete intervals.

In an example in which massage device 100 includes a plurality of separation adjustment mechanisms 140 (e.g., one or more support separation adjustment mechanisms 142 and/or one or more frame separation adjustment mechanisms 144), two or more separation adjustment mechanisms 140 may be configured to permit selective variation of selected separation distance 170 in distinct manners. As an example, the plurality of separation adjustment mechanisms 140 may include at least one support separation adjustment mechanism 142 that is configured to permit selected separation distance 170 to be continuously adjustable, as well as at least one frame separation adjustment mechanism 144 that is configured to permit the selected separation distance to be discretely adjustable. As another example, the plurality of separation adjustment mechanisms 140 may include at least one support separation adjustment mechanism 142 that is configured to permit selected separation distance 170 to be discretely adjustable, as well as at least one frame separation adjustment mechanism 144 that is configured to permit the selected separation distance to be continuously adjustable.

In an example in which separation adjustment mechanism 140 includes and/or is support separation adjustment mechanism 142, support separation adjustment mechanism 142 may be configured to enable adjustment of first support member 150 and/or of second support member 160 in any appropriate manner. In some examples, support separation adjustment mechanism 142 may be configured to permit first support member 150 and/or second support member 160 to be selectively and operatively coupled to and uncoupled from frame 110 when separation adjustment mechanism 140 is in the adjustment configuration.

As a more specific example, support separation adjustment mechanism 142 may be configured to permit first support member 150 and/or second support member 160 to be selectively and operatively coupled to frame 110 at any of a discrete plurality of predefined locations when support separation adjustment mechanism 142 is in the adjustment configuration. In some such examples, and as schematically illustrated in FIG. 1, frame 110 (and/or first frame side 130 and/or second frame side 132 thereof) includes a plurality of spaced-apart support receivers 134, each support receiver 134 configured to selectively support and/or receive at least a portion of first support member 150 or second support member 160. In such examples, when support separation adjustment mechanism 142 is in the use configuration, support separation adjustment mechanism 142 may be configured to selectively support, engage, and/or otherwise retain each of first support member 150 and/or second support member 160 with one or more respective support receivers 134 to selectively maintain a fixed selected separation distance 170. Alternatively, when support separation adjustment mechanism 142 is in the adjustment configuration, support separation adjustment mechanism 142 may permit first support member 150 and/or second support member 160 to be selectively removed from the respective support receivers 134 to adjust selected separation distance 170, such as by moving first support member 150 and/or second support member 160 to different respective support receivers 134.

In an example in which frame 110 includes support receivers 134, each support receiver 134 may have any appropriate structure for selectively retaining first support member 150 and/or second support member 160. As an example, and as schematically illustrated in FIG. 1, each support receiver 134 may include and/or be a bore that extends at least partially through frame 110, such as through first frame side 130 and/or through second frame side 132. In such examples, frame 110 (and/or first frame side 130 and/or second frame side 132) may be described as defining each support receiver 134. In such examples, first support member 150 and/or second support member 160 may be operatively retained within each support receiver 134 when support separation adjustment mechanism 142 is in the use configuration, such as to restrict the first support member and/or the second support member from being removed from the respective support receiver(s). As a more specific example, and as described herein, support separation adjustment mechanism 142 may include a retention element, such as a bolt or a nut, that operatively engages first support member 150 and/or second support member 160 to restrict removal of the first support member and/or the second support member from frame 110. Accordingly, in such examples, transitioning support separation adjustment mechanism 142 from the use configuration to the adjustment configuration may include removing the retention element from the support member (i.e., first support member 150 or second support member 160) to enable the support member to be removed from frame 110.

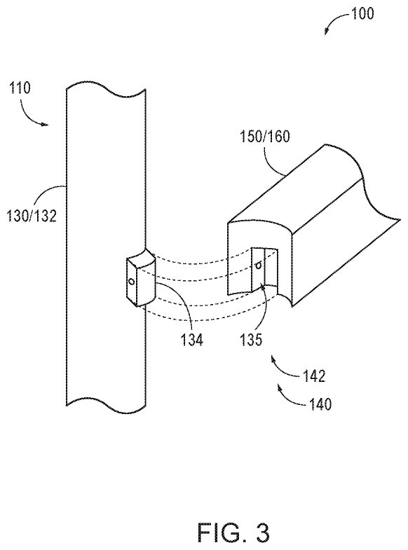

In other examples, and as further schematically illustrated in FIG. 1, each support receiver 134 may include and/or be an extension (e.g., a tab, a peg, etc.) that is operatively coupled to and extends away from frame 110, such as from first frame side 130 and/or second frame side 132. In such examples, each support receiver 134 may be integrally formed with frame 110, or may be a distinct component that is operatively coupled to and/or affixed to frame 110. In such examples, each of first support member 150 and/or second support member 160 may include a notch, a groove, and/or any other suitable structural feature for operatively engaging support receiver 134 while support separation adjustment mechanism 142 is in the use configuration. As a more specific example, FIG. 3 illustrates an example in which support receiver 134 takes the form of a tab that extends away from a side of frame 110 (i.e., first frame side 130 or second frame side 132) and in which first support member 150 and/or second support member 160 includes a receiver notch 135 that operatively receives support receiver 134 when support separation adjustment mechanism 142 is in the use configuration. In some examples, and as illustrated in FIG. 3, support receiver 134 and/or receiver notch 135 may include a locking mechanism, such as a snap-in mechanism and/or a selectively releasable locking mechanism, that restricts support receiver 134 from being removed from receiver notch 135 when support separation adjustment mechanism 142 is in the use configuration. As a more specific example, FIG. 3 illustrates an example in which support receiver 134 includes a pair of locking projections (one of which is visible in FIG. 3) that are received within a corresponding pair of indentations formed in receiver notch 135 (one of which is visible in FIG. 3) to restrict the support receiver from being removed from the receiver notch. In such an example, the locking projection may be a spring-biased snap-lock mechanism, and/or may be selectively retracted via an external actuator to permit removal of the support receiver from the receiver notch.

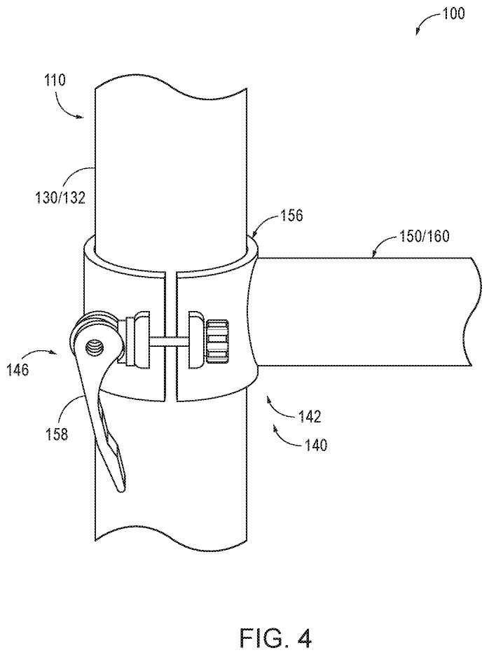

In other examples, support separation adjustment mechanism 142 may be configured to permit first support member 150 and/or second support member 160 to be operatively coupled to frame 110 at any of a continuum of locations (e.g., a continuous plurality of locations) when separation adjustment mechanism 140 is in the adjustment configuration. As a more specific example, and as schematically illustrated in FIG. 1, support separation adjustment mechanism 142 may be operatively coupled to each of frame 110 and a support member (i.e., first support member 150, as schematically illustrated in FIG. 1, or second support member 160), and support separation adjustment mechanism 142 may be configured to selectively retain the support member relative to the frame when support separation adjustment mechanism 142 is in the use configuration. As a more specific example, FIG. 4 illustrates an example in which support separation adjustment mechanism 142 includes a support member collar 156 that is operatively coupled to the support member (i.e., first support member 150 or second support member 160) and that extends at least substantially circumferentially around a portion of frame 110 (e.g., first frame side 130 or second frame side 132) to operatively couple the support member to the frame.

In such an example, and as shown in FIG. 4, support separation adjustment mechanism 142 and/or support member collar 156 may include separation adjustment mechanism actuator 146 in the form of a collar lock mechanism 158 for selectively tightening or loosening support member collar 156 around frame 110. Collar lock mechanism 158 may be configured to selectively secure support member collar 156, and hence the associated support member, in any desired position relative to frame 110. In this manner, in such examples, collar lock mechanism 158 may be configured to transition support separation adjustment mechanism 142 between the use configuration, in which support member collar 156 is fixedly coupled to frame 110, and the adjustment configuration, in which support member collar 156 is free to translate along frame 110 to selectively adjust selected separation distance 170. In such examples, separation adjustment mechanism actuator 146 and/or collar lock mechanism 158 may include and/or be any appropriate mechanism, examples of which include a cam lock mechanism (as illustrated in FIG. 4), a twist-lock mechanism, a clamp screw mechanism, a set screw mechanism, etc.

In some examples, separation adjustment mechanism 140 is configured to enable adjustment of selected separation distance 170 without repositioning first support member 150 and/or second support member 160 relative to frame 110. For example, and as discussed, separation adjustment mechanism 140 may include and/or be frame separation adjustment mechanism 144 that permits selective variation of selected separation distance 170 via adjustment of frame 110 alone. As an example, and as schematically illustrated in FIG. 1, first frame side 130 and/or second frame side 132 may be an expanding frame side 136 that is configured to selectively expand and retract in length to adjust selected separation distance 170 when frame separation adjustment mechanism 144 is in the adjustment configuration. More specifically, in such examples, and as discussed in combination with FIG. 1, expanding frame side 136 (e.g., first frame side 130 or second frame side 132) may include two or more distinct frame side segments 138 that are configured to move (e.g., translate) relative to one another to selectively lengthen or shorten expanding frame side 136, thereby adjusting selected separation distance 170. That is, in such examples, and as schematically illustrated in FIG. 1, first support member 150 may be operatively coupled to a first frame side segment 138 (or to each of a first pair of frame side segments 138), while second support member 160 may be operatively coupled to a second frame side segment 138 (or to each of a second pair of frame side segments 138) such that moving the frame side segments relative to one another adjusts a distance between the first support member and the second support member. Stated differently, in such examples, and as schematically illustrated in FIG. 1, first support member 150 may be operatively coupled to first frame portion 116, and second support member 160 may be operatively coupled to second frame portion 118.

In some examples, frame side 136 may be configured such that the corresponding frame side segments 138 are configured to expand and/or contract in a telescoping manner, with at least a portion of each frame side segment 138 being received within another frame side segment 138 and/or receiving at least a portion of another frame side segment 138. In other examples, frame side 136 may be configured such that the corresponding frame side segments 138 extend adjacent to one another and/or at least substantially parallel to one another (e.g., exterior of one another).

In an example in which frame 110 includes one or more expanding frame sides 136, frame separation adjustment mechanism 144 may be configured to selectively permit expanding frame side(s) 136 to expand and contract when in the adjustment configuration, and frame separation adjustment mechanism 144 may be configured to restrict expanding frame side(s) 136 from expanding or contracting when in the use configuration. In such examples, frame separation adjustment mechanism 144 may include adjustment mechanism actuator 146 in the form of any appropriate mechanism for selectively restricting and permitting the relative motion of frame side segments 138 of expanding frame side 136 and/or of first frame portion 116 relative to second frame portion 118. As more specific examples, adjustment mechanism actuator 146 may include and/or be a cam lock mechanism, a twist-lock mechanism, a clamp srew mechanism, a set screw mechanism, a geared mechanism, and/or a ratchet mechanism that is configured to restrict expanding frame side(s) 136 from expanding and/or contracting when frame separation adjustment mechanism 144 is in the use configuration.

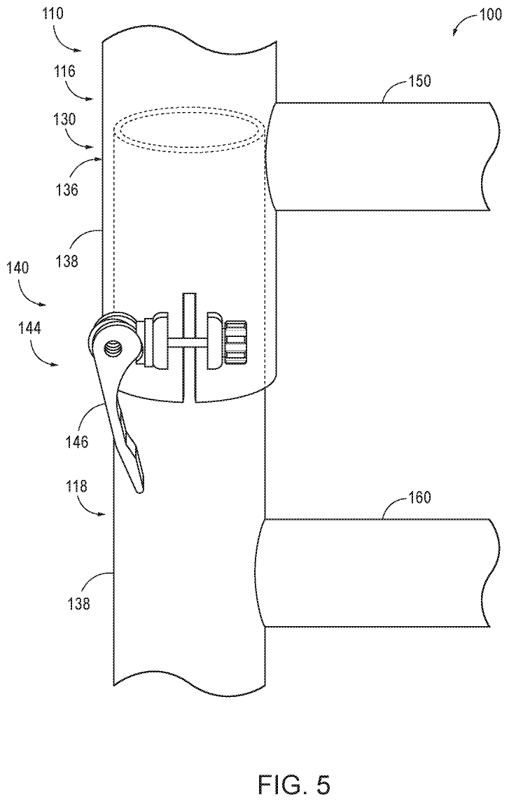

In some examples, such as when frame separation adjustment mechanism 144 includes a cam lock mechanism, a twist-lock mechanism, a clamp screw mechanism, and/or a set screw mechanism, frame separation adjustment mechanism 144 may be configured to enable infinite (e.g., continuous) adjustability of selected separation distance 170. As a more specific example, FIG. 5 illustrates an example in which first frame side 130 of frame 110 is an expanding frame side 136 with frame side segments 138 arranged in a telescoping configuration, and in which frame separation adjustment mechanism 144 includes adjustment mechanism actuator 146 in the form of a cam lock lever. Thus, in the example of FIG. 5, the separation between first support member 150 and second support member 160, and thus selected separation distance 170 (not labelled in FIG. 5) may be selectively adjusted by first transitioning frame separation adjustment mechanism 144 to the adjustment configuration by releasing adjustment mechanism actuator 146. With the frame separation adjustment mechanism in the adjustment configuration, first frame portion 116 and second frame portion 118 may be translated relative to one another to produce a desired selected separation distance, and frame separation adjustment mechanism 144 then may be transitioned to the use configuration by locking the adjustment mechanism actuator.

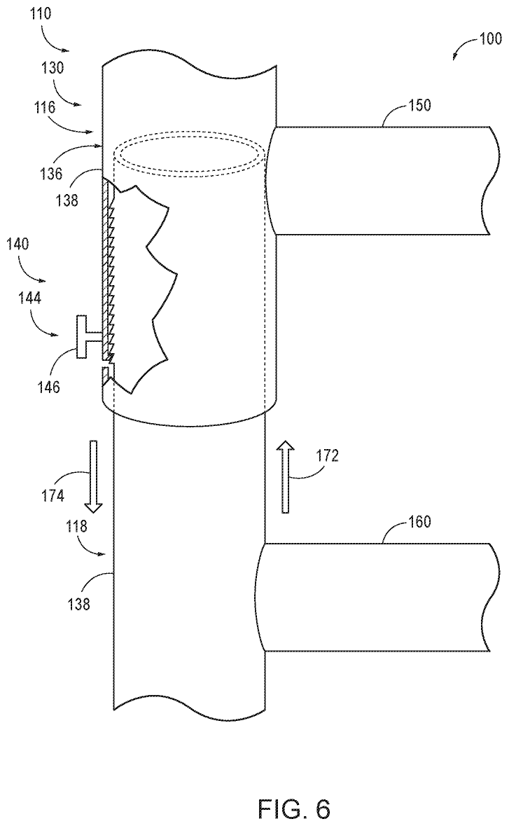

In other examples, such as when frame separation adjustment mechanism 144 includes a ratchet mechanism, frame separation adjustment mechanism 144 may be configured to selectively position each frame side segment 138 at one of a discrete plurality of positions relative to one another. As a more specific example, FIG. 6 illustrates an example in which a frame side (i.e., first frame side 130 or second frame side 132) includes a pair of telescoping frame side segments, and in which frame separation adjustment mechanism 144 includes a ratchet mechanism that operatively interconnects the frame side segments. More specifically, in the example of FIG. 6, frame separation adjustment mechanism 144 includes a ratchet mechanism that permits the second frame portion 118 to translate relative to the first frame portion 116 in a first adjustment direction 172 when frame separation adjustment mechanism 144 is in either of the use configuration (as illustrated in FIG. 6) or the adjustment configuration. In this example, the ratchet mechanism of frame separation adjustment mechanism 144 restricts second frame portion 118 from translating relative to first frame portion 116 in a second adjustment direction 174, which is opposite first adjustment direction 172, when frame separation adjustment mechanism 144 is in the use configuration.

In the example of FIG. 6, frame separation adjustment mechanism 144 includes adjustment mechanism actuator 146 in the form of a resilient tab for selectively releasing the ratchet mechanism to transition frame separation adjustment mechanism 144 to the adjustment configuration. Specifically, in this example, the resilient tab is biased inwardly, such that frame separation adjustment mechanism 144 is biased toward the use configuration, and the resilient tab may be selectively translated outward to transition the frame separation adjustment mechanism to the adjustment configuration.

In the example of FIG. 6, translating second frame portion 118 relative to first frame portion 116 in first adjustment direction 172 (or, equivalently, translating first frame portion 116 relative to second frame portion 118 along second adjustment direction 174) generally corresponds to and/or results in a decrease in selected separation distance 170 (not labeled in FIG. 6). Similarly, in the example of FIG. 6, translating second frame portion 118 relative to first frame portion 116 in second adjustment direction 174 (or, equivalently, translating first frame portion 116 relative to second frame portion 118 along first adjustment direction 172) generally corresponds to and/or results in an increase in selected separation distance 170 (not labeled in FIG. 6). In this manner, FIG. 6 represents an example in which frame separation adjustment mechanism 144 permits selected separation distance 170 to be selectively decreased and in which the frame separation adjustment mechanism restricts the selected separation distance from being increased while the frame separation adjustment mechanism is in the use configuration. However, this is not required of all examples, and it is additionally within the scope of the present disclosure that frame separation adjustment mechanism 144 may permit selected separation distance 170 to be selectively increased while the frame separation adjustment mechanism is in the use configuration. As an example, frame separation adjustment mechanism 144 may include and/or be a ratchet mechanism that at least partially restricts selected separation distance 170 from being increased during operative use of massage device 100 to massage limb 10. More specifically, in such examples, the frame separation adjustment mechanism may permit the selected separation distance to be selectively increased when first frame portion 116 and second frame portion 118 are urged away from one another with at least a threshold adjusting force. In other examples, expanding frame side 136 may include a plurality of frame side segments 138 that are positioned adjacent to and exterior of one another. In such examples, frame separation adjustment mechanism 144 and/or adjustment mechanism actuator 146 may include and/or be a mechanism for selectively retaining the plurality of frame side segments 138 in a configuration that is at least substantially fixed while frame separation adjustment mechanism 144 is in the use configuration.

In some examples, separation adjustment mechanism 140 may be configured for one-handed operation, and/or may be configured to permit adjustment of selected separation distance 170 while limb 10 extends between first massage element 152 and second massage element 162. In some examples, massage device 100 may be configured to be operatively coupled to and/or supported by an external object (e.g., an object other than a component of massage device 100 or of the user) during operative use thereof. For example, and as schematically illustrated in FIG. 1, massage device 100 additionally may include a mounting structure 190 configured to selectively and operatively couple massage device 100 to a support structure during operative use of massage device 100. Examples of support structures may include a piece of furniture, a door, a table, a counter, a bar, a chair, and/or any other suitable rigid and/or stationary object. Mounting structure 190 may include and/or be any appropriate structure for mounting massage device 100, examples of which include a bracket a clamp, a strap, and/or a suction cup.

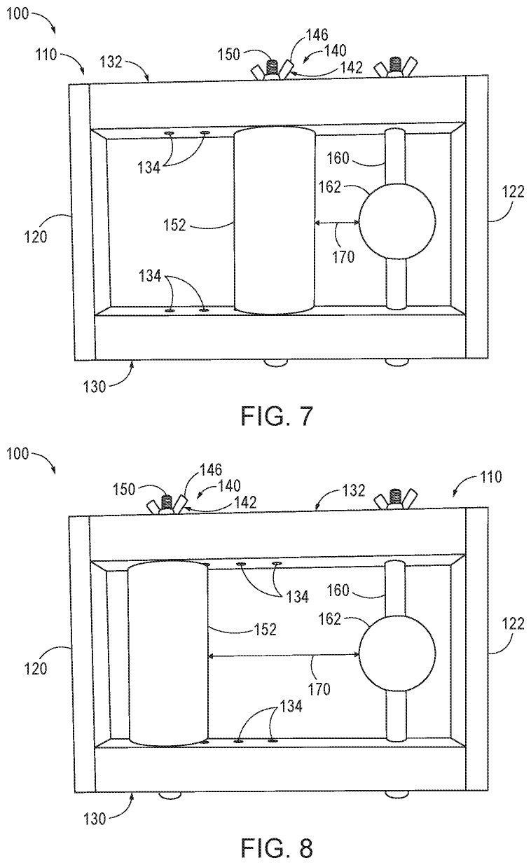

FIGS. 7-18 provide less schematic illustrations of examples of massage device 100 according to the present disclosure, as described in more detail below. The examples of FIGS. 7-18 are not limiting with respect to the features, aspects, and/or components that may be associated with a particular example of massage device 100, and it is within the scope of the present disclosure that any features, aspects, and/or components of any of the examples of FIGS. 7-18 may be utilized with and/or incorporated into any other example of massage device 100 according to the present disclosure.

FIGS. 7-8 illustrate a first example of massage device 100. In the example of FIGS. 7-8, frame 110 includes first frame side 130, second frame side 132, first frame end 120, and second frame end 122. In this example, each of first frame side 130 and second frame side 132 includes a plurality of support receivers 134 in the form of bores extending through the first frame side and the second frame side. In this example, first massage element 152 is a cylindrical roller, such as a foam roller, and second massage element 162 is a ball, such as a rubber ball. In this example, first support member 150 takes the form of a rod that is selectively inserted into a pair of opposed support receivers 134 to define selected separation distance 170. In this example, separation adjustment mechanism 140 takes the form of support separation adjustment mechanism 142, which includes adjustment mechanism actuator 146 in the form of a nut that threads onto first support member 150 to selectively retain the first support member in the selected pair of opposed support receivers 134. Thus, in this example, separation adjustment mechanism 140 is in the use configuration when first support member 150 is inserted into a selected pair of opposed support receivers 134 and adjustment mechanism actuator 146 is threaded onto the first support member, and separation adjustment mechanism 140 is in the adjustment configuration when the adjustment mechanism actuator is removed from the first support member and the first support member is removed from the frame. FIGS. 7-8 respectively illustrate first support member 150 as being in distinct pairs of opposed support receivers 134, such that selected separation distance 170 is greater in the example of FIG. 8 relative to the example of FIG. 7.

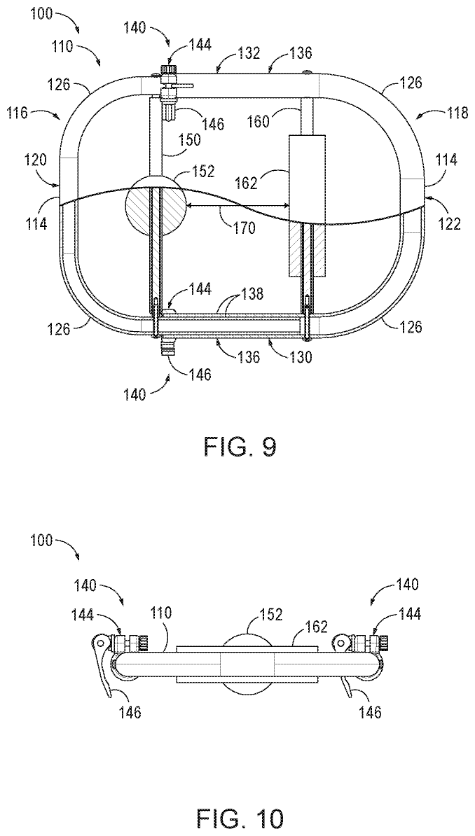

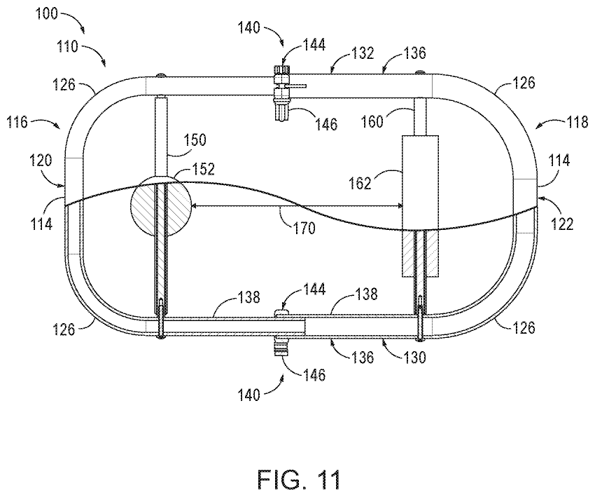

FIGS. 9-11 illustrate a second example of massage device 100. Specifically, each of FIGS. 9 and 11 is a semi-cross-sectional view in which the lower half of the figure represents a cross-sectional view of the massage device. In the example of FIGS. 9-11, and as labelled in FIGS. 9 and 11, frame 110 includes first frame side 130, second frame side 132, first frame end 120, and second frame end 122. In this example, and as labelled in FIGS. 9 and 11, each of first frame side 130 and second frame side 132 is an expanding frame side 136 that includes a pair of frame side segments 138 arranged in a telescoping manner. In this example, frame 110 includes first frame portion 116, which includes a first (left-hand/inner) frame side segment 138 of first frame side 130 coupled to first frame end 120 via a first (lower-left) frame transition region 126 and a first (left-hand/inner) frame side segment 138 of second frame side 132 coupled to the first frame side via a second (upper-left) frame transition region 126. Thus, in this example, the components of first frame portion 116 are continuous and integrally formed with one another. Similarly, in this example, frame 110 additionally includes second frame portion 118, which includes a second (right-hand/outer) frame side segment 138 of first frame side 130 coupled to second frame end 122 via a second (lower-right) frame transition region 126 and a second (right-hand/outer) frame side segment 138 of second frame side 132 coupled to the second frame end via a second (upper-right) frame transition region 126. Thus, in this example, the components of second frame portion 118 are continuous and integrally formed with one another.

In the example of FIGS. 9-11, first massage element 152 is a ball, such as a rubber ball, and second massage element 162 is a cylindrical roller, such as a foam roller. In this example, and as shown in FIGS. 9 and 11, each of first support member 150 and second support member 160 takes the form of a rod that is operatively and fixedly coupled to each of first frame side 130 and second frame side 132. Specifically, in this example, first support member 150 is coupled to first frame portion 116, while second support member 160 is coupled to second frame portion 118.

In the example of FIGS. 9-11, and as perhaps best seen in FIG. 10, massage device 100 includes a pair of separation adjustment mechanisms 140 in the form of a pair of frame separation adjustment mechanisms 144, each of which includes adjustment mechanism actuator 146 in the form of a cam lever for selectively tightening a cam mechanism to selectively secure the corresponding pair of frame side segments 138 (labelled in FIGS. 9 and 11) relative to one another. Thus, in this example, each separation adjustment mechanism 140 is in the use configuration when the corresponding adjustment mechanism actuator 146 is in a closed position, as illustrated in FIGS. 9-11, and each separation adjustment mechanism is in the adjustment configuration when the corresponding adjustment mechanism actuator is in an open position. In this example, selected separation distance 170 may be selectively adjusted only when both separation adjustment mechanisms 140 are in the adjustment configuration. FIGS. 9 and 11 respectively illustrate each expanding frame side 136 as being in distinct telescoping configurations, such that selected separation distance 170 is greater in the configuration of FIG. 11 relative to the configuration of FIG. 9.

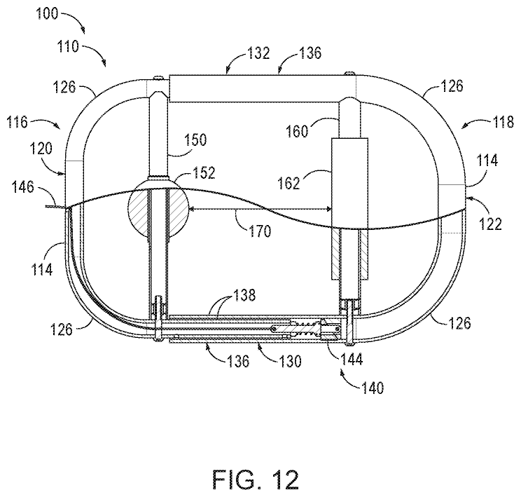

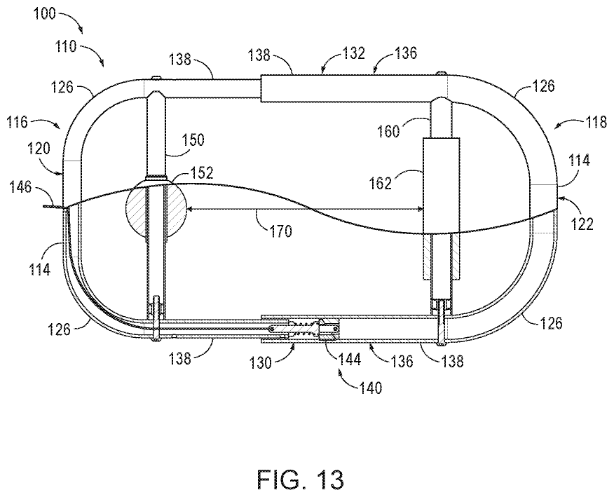

FIGS. 12-13 illustrate a third example of massage device 100. Specifically, each of FIGS. 12-13 is a semi-cross-sectional view in which the lower half of the figure represents a cross-sectional view of the massage device. In the example of FIGS. 12-13, similar to the example of FIGS. 9-11, frame 110 includes first frame side 130, second frame side 132, first frame end 120, and second frame end 122. In this example, each of first frame side 130 and second frame side 132 is an expanding frame side 136 that includes a pair of frame side segments 138 arranged in a telescoping manner. In this example, frame 110 includes first frame portion 116, which includes a first (left-hand/inner) frame side segment 138 of first frame side 130 coupled to first frame end 120 via a first (lower-left) frame transition region 126 and a first (left-hand/inner) frame side segment 138 of second frame side 132 coupled to the first frame side via a second (upper-left) frame transition region 126. Thus, in this example, the components of first frame portion 116 are continuous and integrally formed with one another. Similarly, in this example, frame 110 additionally includes second frame portion 118, which includes a second (right-hand/outer) frame side segment 138 of first frame side 130 coupled to second frame end 122 via a second (lower-right) frame transition region 126 and a second (right-hand/outer) frame side segment 138 of second frame side 132 coupled to the second frame end via a second (upper-right) frame transition region 126. Thus, in this example, the components of second frame portion 118 are continuous and integrally formed with one another.

In the example of FIGS. 12-13, first massage element 152 is a ball, such as a rubber ball, and second massage element 162 is a cylindrical roller, such as a foam roller. Similar to the example of FIGS. 9-11, in this example, each of first support member 150 and second support member 160 takes the form of a rod that is operatively and fixedly coupled to each of first frame side 130 and second frame side 132. Specifically, in this example, first support member 150 is coupled to the first (left-hand/inner) frame side segments 138 of each of first frame side 130 and second frame side 132, while second support member 160 is coupled to the second (right-hand/outer) frame side segments 138 of each of the first frame side and the second frame side.

In the example of FIGS. 12-13, and as perhaps best seen in FIG. 10, massage device 100 includes a separation adjustment mechanism 140 in the form of a frame separation adjustment mechanism 144 that utilizes a biased-wedge mechanism inserted into first frame side 130 to selectively secure the corresponding pair of frame side segments 138 relative to one another. Specifically, in this example, the biased-wedge mechanism includes a pair of wedge portions that are biased radially outward within frame side segment 138 of second frame portion 118 by a biasing spring. Frame separation adjustment mechanism 144 further includes adjustment mechanism actuator 146 in the form of a lever extending from the biased-wedge mechanism, through a frame side segment 138 of first frame portion 116 and out of first frame end 120. In this manner, frame separation adjustment mechanism 144 is configured such that selectively manipulating adjustment mechanism actuator 146 urges the wedge portions out of engagement with second frame portion 118, permitting relative motion between first frame portion 116 and second frame portion 118. Thus, in this example, separation adjustment mechanism 140 is in the use configuration when adjustment mechanism actuator 146 is left in its nominal position, as illustrated in FIGS. 12-13, and the separation adjustment mechanism is in the adjustment configuration while the adjustment mechanism actuator is selectively manipulated to disengage the biased-wedge mechanism from the frame side segment 138 of first frame side 130 of second frame portion 118. FIGS. 12 and 13 respectively illustrate each expanding frame side 136 as being in distinct telescoping configurations, such that selected separation distance 170 is greater in the configuration of FIG. 13 relative to the configuration of FIG. 12.

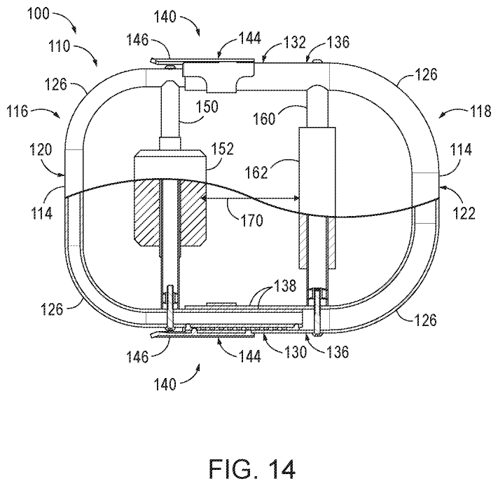

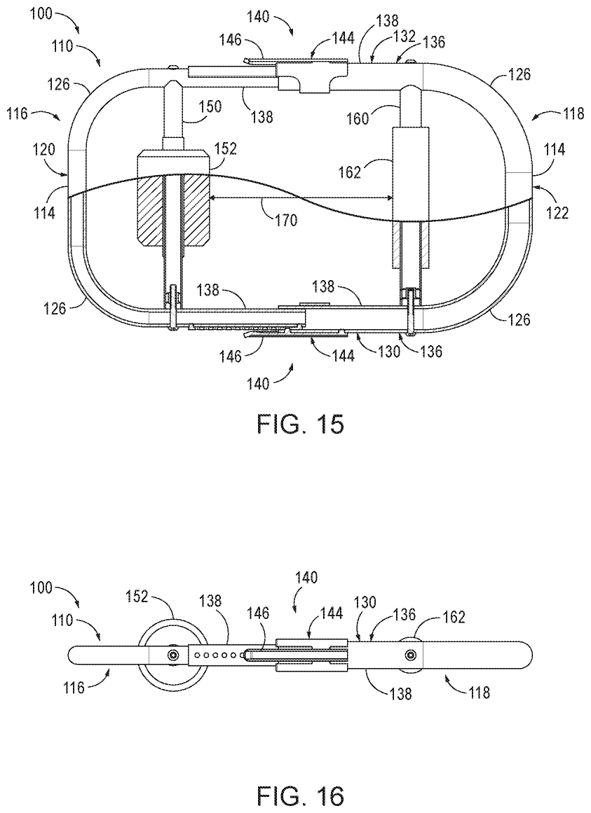

FIGS. 14-16 illustrate a fourth example of massage device 100. Specifically, each of FIGS. 14-15 is a semi-cross-sectional view in which the lower half of the figure represents a cross-sectional view of the massage device. In the example of FIGS. 14-16, similar to the example of FIGS. 9-11 and the example of FIGS. 12-13, and as labelled in FIGS. 14-15, frame 110 includes first frame side 130, second frame side 132, first frame end 120, and second frame end 122. In this example, each of first frame side 130 and second frame side 132 is an expanding frame side 136 that includes a pair of frame side segments 138 arranged in a telescoping manner. In this example, frame 110 includes first frame portion 116, which includes a first (left-hand/inner) frame side segment 138 of first frame side 130 coupled to first frame end 120 via a first (lower-left) frame transition region 126 and a first (left-hand/inner) frame side segment 138 of second frame side 132 coupled to the first frame side via a second (upper-left) frame transition region 126. Thus, in this example, the components of first frame portion 116 are continuous and integrally formed with one another. Similarly, in this example, frame 110 additionally includes second frame portion 118, which includes a second (right-hand/outer) frame side segment 138 of first frame side 130 coupled to second frame end 122 via a second (lower-right) frame transition region 126 and a second (right-hand/outer) frame side segment 138 of second frame side 132 coupled to the second frame end via a second (upper-right) frame transition region 126. Thus, in this example, the components of second frame portion 118 are continuous and integrally formed with one another.

In the example of FIGS. 14-16, each of first massage element 152 and second massage element 162 is a cylindrical roller, such as a foam roller. In this example, and as shown in FIGS. 14-15, each of first support member 150 and second support member 160 takes the form of a rod that is operatively and fixedly coupled to each of first frame side 130 and second frame side 132. Specifically, in this example, first support member 150 is coupled to first frame portion 116, while second support member 160 is coupled to second frame portion 118.

In the example of FIGS. 14-16, massage device 100 includes a pair of separation adjustment mechanisms 140 in the form of a pair of frame separation adjustment mechanisms 144, each of which includes adjustment mechanism actuator 146 in the form of a resilient lever for selectively positioning first frame portion 116 relative to second frame portion 118. Specifically, in this example, each adjustment mechanism actuator 146 is operatively coupled to second frame portion 118 and is configured to selectively engage a selected lock indentation (best illustrated in FIG. 16) on a portion of frame separation adjustment mechanism 144 that is operatively coupled to first frame portion 116. In this manner, frame separation adjustment mechanism 144 in this example enables selected separation distance 170 to be varied among a plurality of discrete separation distances, defined by the plurality of lock indentations. Thus, in this example, each frame separation adjustment mechanism 144 is configured such that selectively manipulating adjustment mechanism actuator 146 transitions the frame separation adjustment mechanism to the adjustment configuration by disengaging the respective portions of the frame separation adjustment mechanism attached to first frame portion 116 and second frame portion 118. Subsequently releasing the adjustment mechanism actuators permits the resilient lever to engage a selected lock indentation to transition the frame separation adjustment mechanism to the use configuration. In this example, selected separation distance 170 may be selectively adjusted only when both separation adjustment mechanisms 140 are in the adjustment configuration. FIGS. 14 and 15 respectively illustrate each expanding frame side 136 as being in distinct telescoping configurations, such that selected separation distance 170 is greater in the configuration of FIG. 15 relative to the configuration of FIG. 14.

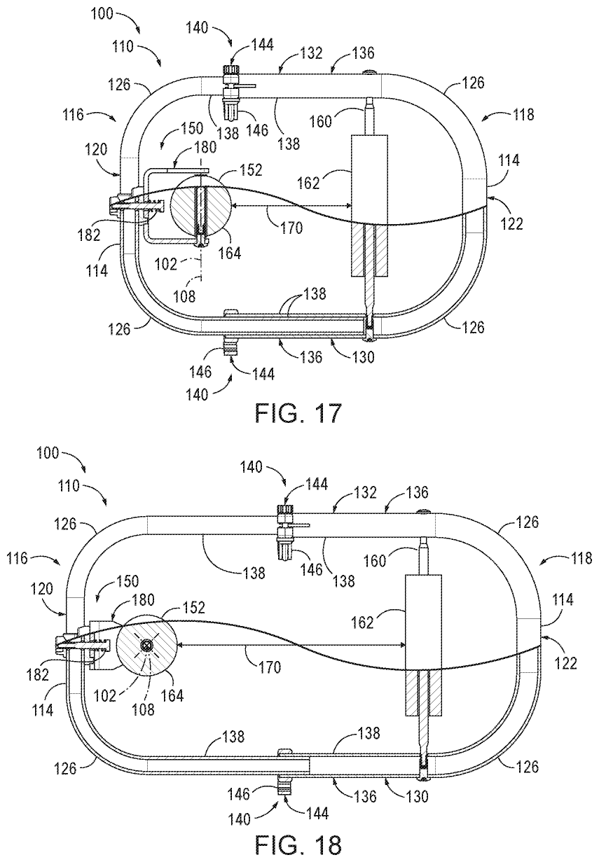

FIGS. 17-18 illustrate a fifth example of massage device 100. Specifically, each of FIGS. 17-18 is a semi-cross-sectional view in which the lower half of the figure represents a cross-sectional view of the massage device. In the example of FIGS. 17-18, frame 110 includes first frame side 130, second frame side 132, first frame end 120, and second frame end 122. In this example, each of first frame side 130 and second frame side 132 is an expanding frame side 136 that includes a pair of frame side segments 138 arranged in a telescoping manner. In this example, frame 110 includes first frame portion 116, which includes a first (left-hand/inner) frame side segment 138 of first frame side 130 coupled to first frame end 120 via a first (lower-left) frame transition region 126 and a first (left-hand/inner) frame side segment 138 of second frame side 132 coupled to the first frame side via a second (upper-left) frame transition region 126. Thus, in this example, the components of first frame portion 116 are continuous and integrally formed with one another. Similarly, in this example, frame 110 additionally includes second frame portion 118, which includes a second (right-hand/outer) frame side segment 138 of first frame side 130 coupled to second frame end 122 via a second (lower-right) frame transition region 126 and a second (right-hand/outer) frame side segment 138 of second frame side 132 coupled to the second frame end via a second (upper-right) frame transition region 126. Thus, in this example, the components of second frame portion 118 are continuous and integrally formed with one another.

In the example of FIGS. 17-18, first massage element 152 is a ball, such as a rubber ball, and second massage element 162 is a cylindrical roller, such as a foam roller. Similar to the example of FIGS. 9-11 and the example of FIGS. 12-13, second support member 160 takes the form of a rod that is operatively and fixedly coupled to each of first frame side 130 and second frame side 132 of second frame portion 118. In the example of FIGS. 17-18, however, first support member 150 takes the form of repositionable rotation support 180 operatively coupled to first frame end 120, such that first massage element 152 is a multi-axis massage element 164. Thus, as illustrated in FIGS. 17-18, first massage element 152 is configured to rotate relative to frame 110 about first axis of rotation 102, which is a variable axis of rotation 108. In the example of FIGS. 17-18, repositionable rotation support 180 includes repositioning mechanism 182 for selectively varying the orientation of variable axis of rotation 108 relative to frame 110. In particular, in this example, repositioning mechanism 182 includes a spring-biased mechanism that biases repositionable rotation support 180 toward first frame end 120, such that the variable axis of rotation may be selectively adjusted by pulling the repositionable rotation support away from the first frame side (e.g., toward second frame end 122) and rotating the repositionable rotation support relative to the frame. FIGS. 17 and 18 respectively illustrate repositionable rotation support 180 as being in distinct orientations relative to frame 110. Specifically, FIG. 18 illustrates a configuration in which repositionable rotation support 180, and hence variable axis of rotation 108, has been rotated by 90 degrees relative to the configuration of FIG. 17.

In the example of FIGS. 17-18, massage device 100 includes a pair of separation adjustment mechanisms 140 in the form of a pair of frame separation adjustment mechanisms 144, each of which includes adjustment mechanism actuator 146 in the form of a cam lever for selectively tightening a cam mechanism to selectively secure the corresponding pair of frame side segments 138 relative to one another. Thus, in this example, each separation adjustment mechanism 140 is in the use configuration when the corresponding adjustment mechanism actuator 146 is in a closed position, as illustrated in FIGS. 17-18, and each separation adjustment mechanism is in the adjustment configuration when the corresponding adjustment mechanism actuator is in an open position. In this example, selected separation distance 170 may be selectively adjusted only when both separation adjustment mechanisms 140 are in the adjustment configuration. FIGS. 17 and 18 respectively illustrate each expanding frame side 136 as being in distinct telescoping configurations, such that selected separation distance 170 is greater in the configuration of FIG. 18 relative to the configuration of FIG. 17.

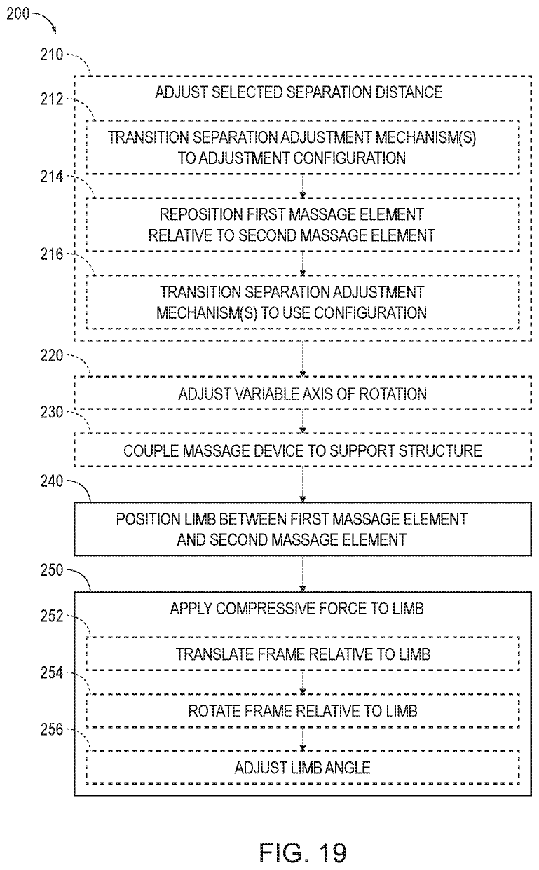

FIG. 19 is a flowchart depicting examples of methods 200, according to the present disclosure, of utilizing a massage device (such as massage device 100) to massage a limb (such as limb 10) of a user. As shown in FIG. 19, methods 200 include positioning, at 240, the limb of the user between a first massage element (such as first massage element 152) and a second massage element (such as second massage element 162) of the massage device and applying, at 250, a compressive force to the limb with each of the first massage element and the second massage element.

As shown in FIG. 19, the applying the compressive force to the limb at 250 may include moving the limb and/or the massage device relative to one another in any appropriate manner to apply the compressive force. For example, as shown in FIG. 19, the applying the compressive force at 250 may include translating, at 252, a frame (such as frame 110) of the massage device relative to the limb, such as along a direction that is at least substantially parallel to a limb axis (such as limb axis 12) of the limb. Equivalently, the translating at 252 may include translating the limb relative to the frame, such as along the direction that is at least substantially parallel to the limb axis. In this manner, the translating the frame relative to the limb at 252 may include translating each of the first massage element and the second massage element relative to the limb, such as to roll each of the first massage element and the second massage element along the limb while applying the compressive force to the limb with the first massage element and the second massage element.

Additionally or alternatively, and as further shown in FIG. 19, the applying the compressive force to the limb at 250 may include rotating, at 254, the frame relative to the limb, such as about the limb axis of the limb. Equivalently, the rotating at 254 may include rotating the limb relative to the frame about the limb axis. In this manner, rotating the frame relative to the limb at 254 may include moving, rolling, and/or revolving the first massage element and/or the second massage element around the limb while in contact with the limb and while applying the compressive force to the limb.

Additionally or alternatively, and as further shown in FIG. 19, the applying the compressive force to the limb at 250 may include selectively adjusting, at 256, a limb angle (such as limb angle 14) formed between the limb axis and a device plane (such as device plane 112) of the massage device while the limb is positioned between the first massage element and the second massage element. In this manner, the adjusting the limb angle at 256 may include and/or correspond to adjusting the compressive force applied to the limb by the first massage element and/or by the second massage element. Additionally or alternatively, the adjusting the limb angle at 256 may include and/or correspond to accommodating a variation in a limb width (such as limb width 16) of the limb in a portion of the limb that is being massaged. The selectively adjusting the limb angle at 256 may be performed in any appropriate manner, such as by tilting the massage device relative to the limb and/or by tilting the limb relative to the massage device.

In some examples, methods 200 include one or more steps for configuring the massage device for the limb to be massaged and/or for the manner in which the limb is to be massaged. For example, and as shown in FIG. 19, methods 200 additionally may include, prior to the positioning the limb at 240, selectively adjusting, at 210, a selected separation distance (such as selected separation distance 170) between the first massage element and the second massage element with one or more separation adjustment mechanisms (such as separation adjustment mechanism(s) 140). More specifically, in such examples, and as shown in FIG. 19, the adjusting the selected separation distance at 210 may include transitioning, at 212, the separation adjustment mechanism(s) to an adjustment configuration and transitioning, at 216, the separation adjustment mechanism(s) to a use configuration. In such examples, the adjusting the selected separation distance at 210 may include, while the separation adjustment mechanism(s) is/are in the adjustment configuration, repositioning, at 214, the first massage element relative to the second massage element to define the selected separation distance. In some examples, the transitioning at 212 and/or the transitioning at 216 is performed via selective manipulation of an adjustment mechanism actuator (such as adjustment mechanism actuator 146).

The selectively adjusting the selected separation distance at 210 may include utilizing the separation adjustment mechanism(s) in any appropriate manner as disclosed herein. For example, the separation adjustment mechanism(s) may include one or more support separation adjustment mechanisms (such as support separation adjustment mechanism(s) 142) that selectively enable a first support member (such as first support member 150) and a second support member (such as second support member 160) to be repositioned relative to one another. In such examples, the transitioning at 212 may include transitioning the support separation adjustment mechanism(s) to the adjustment configuration, and/or the transitioning at 216 may include transitioning the support separation adjustment mechanism(s) to the use configuration. As another example, the separation adjustment mechanism(s) may include one or more frame separation adjustment mechanisms (such as frame separation adjustment mechanism(s) 144) that selectively enable adjustment of the selected separation distance via a selective reconfiguration of the frame. In such examples, the transitioning at 212 may include transitioning the frame separation adjustment mechanism(s) to the adjustment configuration, and/or the transitioning at 216 may include transitioning the frame separation adjustment mechanism(s) to the use configuration.

The selectively adjusting the selected separation distance at 210 may include configuring the selected separation distance to be compatible with the limb to be massaged, such as by configuring the massage device with a selected separation distance that is at least substantially equal to the limb width of the portion of the limb to be massaged. Additionally or alternatively, the selectively adjusting at 210 may include configuring the selected separation distance to be larger than the limb width, such that the adjusting the limb angle at 256 may serve to bring each of the first massage element and the second massage element into compressive contact with the limb.

In some examples, as shown in FIG. 19, methods 200 additionally may include, prior to the positioning the limb at 240, adjusting, at 220, a variable axis of rotation (such as variable axis of rotation 108) of the first massage element and/or the second massage element. For example, and as discussed, one or both of the first massage element and the second massage element may be a multi-axis massage element (such as multi-axis massage element 164) that is configured to rotate relative to the frame about an axis that is selectable or configurable by the user. Accordingly, in such examples, the adjusting at 220 may include manipulating the multi-axis massage element, and/or a repositionable rotation support (such as repositionable rotation support 180), to adjust and/or define the orientation of the variable axis of rotation relative to the frame.

As further shown in FIG. 19, methods 200 additionally may include, prior to the applying the compressive force at 250, coupling, at 230, the massage device to a support structure. For example, the massage device may include a mounting structure (such as mounting structure 190) that is configured to selectively and operatively couple the massage device to the support structure, and the coupling at 230 may include utilizing the mounting structure to selectively couple the massage device to the support structure. As examples, the coupling at 230 may include utilizing a bracket, a clamp, a strap, and/or a suction cup to operatively couple the massage device to a piece of furniture, a door, a table, a counter, a bar, and/or a chair. In this manner, the coupling at 230 may facilitate and/or enable the massage device to be manipulated by a single hand of the user, such as to apply the compressive force to the user's remaining hand and/or arm.

Examples of massage devices and associated methods according to the present disclosure are described in the following enumerated paragraphs:

A1. A massage device for massaging a limb of a user, the massage device comprising:

a frame;

a first massage element operatively supported by the frame; and

a second massage element operatively supported by the frame;

wherein the first massage element is supported on a first support member that is operatively coupled to the frame; wherein the second massage element is supported on a second support member that is operatively coupled to the frame; wherein the first massage element and the second massage element are selectively maintained at a selected separation distance from one another and wherein the massage device is configured such that each of the first massage element and the second massage element engages the limb to exert a compressive force on the limb as the frame is translated relative to the limb.

A2. The massage device of paragraph A1, wherein the massage device is configured such that, during operative use of the massage device to massage the limb, the massage device is positioned such that the limb extends between the first massage element and the second massage element such that each of the first massage element and the second massage element exerts the compressive force upon the limb.

A3. The massage device of any of paragraphs A1-A2, wherein the selected separation distance is sized to permit the limb of the user to be inserted between the first massage element and the second massage element such that each of the first massage element and the second massage element exerts the compressive force on the limb.

A4. The massage device of any of paragraphs A1-A3, wherein the selected separation distance is selected to be one or more of slightly smaller than a limb width of a portion of the limb to be massaged during operative use of the massage device, slightly larger than the limb width, and at least substantially equal to the limb width.

A5. The massage device of any of paragraphs A1-A4, wherein the massage device is configured such that each of the first massage element and the second massage element remains in rolling contact with the limb across an extent of the limb that exhibits a variation in a/the limb width during operative use of the massage device.

A6. The massage device of any of paragraphs A1-A5, wherein, during operative use of the massage device, the selected separation distance is one or more of at least 5 centimeters (cm), at least 10 cm, at least 15 cm, at least 20 cm, at least 25 cm, at least 30 cm, at least 40 cm, at most 50 cm, at most 45 cm, at most 35 cm, at most 27 cm, at most 22 cm, at most 17 cm, at most 12 cm, and at most 7 cm.

A7. The massage device of any of paragraphs A1-A6, wherein, during operative use of the massage device, a ratio of the selected separation distance to a/the limb width of a/the portion of the limb to be massaged is one or more of at least 0.8:1, at least 1:1, at least 1.2:1, at least 1.5:1, at least 2:1, at most 2.5:1, at most 1.7:1, at most 1.3:1, at most 1.1:1, and at most 0.9:1.

A8. The massage device of any of paragraphs A1-A7, wherein the frame extends within a device plane, and wherein the massage device is configured such that the limb of the user extends through the device plane during operative use of the massage device.

A9. The massage device of paragraph A8, wherein the massage device is configured such that a limb axis of the limb of the user extends at least partially, and optionally at least substantially, perpendicular to the device plane during operative use of the massage device.

A10. The massage device of any of paragraphs A8-A9, wherein the massage device is configured such that, during operative use of the massage device, the limb extends relative to the frame at a limb angle, as measured between the limb axis and the device plane, that is one or more of at least 30 degrees, at least 45 degrees, at least 60 degrees, at least 75 degrees, at most 90 degrees, at most 80 degrees, at most 65 degrees, at most 50 degrees, and at most 35 degrees.

A11. The massage device of paragraph A10, wherein the massage device is configured to enable the user to selectively adjust the limb angle during operative use of the massage device.

A12. The massage device of any of paragraphs A1-A11, wherein the massage device is configured such that, during operative use of the massage device to massage the limb, each of the first massage element and the second massage element rolls without slipping along the limb as the massage device is rotated and/or translated relative to the limb.

A13. The massage device of any of paragraphs A1-A12, wherein the first massage element is configured to rotate relative to the frame about a first axis of rotation, and wherein the second massage element is configured to rotate relative to the frame about a second axis of rotation.

A14. The massage device of paragraph A13, wherein the first axis of rotation and the second axis of rotation are at least substantially parallel to one another.

A15. The massage device of paragraph A13, wherein the first axis of rotation and the second axis of rotation are angled with respect to one another.

A16. The massage device of any of paragraphs A13-A15, wherein one or both of the first axis of rotation and the second axis of rotation each extend within a/the device plane.

A17. The massage device of any of paragraphs A13-A16, wherein each of the first axis of rotation and the second axis of rotation extend within a/the device plane such that the first axis of rotation and the second axis of rotation collectively define the device plane.

A18. The massage device of any of paragraphs A13-A16, wherein one or both of the first axis of rotation and the second axis of rotation intersects a/the device plane.

A19. The massage device of any of paragraphs A1-A18, wherein one or both of the first support member and the second support member extends along a direction that is at least substantially linear.

A20. The massage device of paragraph A19, wherein the first support member and the second support member extend at least substantially parallel to one another.

A21. The massage device of any of paragraphs A1-A20, wherein one or both of the first support member and the second support member includes distinct portions that extend along respective directions that are not parallel to one another.

A22. The massage device of any of paragraphs A1-A21, wherein one or both of the first support member and the second support member is at least partially curved.

A23. The massage device of any of paragraphs A1-A22, wherein one or both of the first support member and the second support member is at least substantially rigid.

A24. The massage device of any of paragraphs A1-A23, wherein one or both of the first support member and the second support member is flexible.

A25. The massage device of any of paragraphs A1-A24, wherein one or both of the first support member and the second support member is fixedly coupled to the frame during operative use of the massage device.

A26. The massage device of paragraph A25, wherein the first support member is fixedly coupled to the frame during operative use of the massage device, and wherein the first massage element is configured to rotate relative to the first support member during operative use of the massage device.

A27. The massage device of paragraph A25, wherein the second support member is fixedly coupled to the frame during operative use of the massage device, and wherein the second massage element is configured to rotate relative to the second support member during operative use of the massage device.

A28. The massage device of any of paragraphs A1-A27, wherein the first support member is configured to rotate relative to the frame about a/the first axis of rotation.

A29. The massage device of paragraph A28, wherein the first massage element is fixedly coupled to the first support member.

A30. The massage device of paragraph A28, wherein the first massage element is rotatably coupled to the first support member.

A31. The massage device of any of paragraphs A1-A30, wherein the second support member is configured to rotate relative to the frame about a/the second axis of rotation.

A32. The massage device of paragraph A31, wherein the second massage element is fixedly coupled to the second support member.

A33. The massage device of paragraph A31, wherein the second massage element is rotatably coupled to the second support member.

A34. The massage device of any of paragraphs A1-A33, wherein one or both of the first massage element and the second massage element is a multi-axis massage element that is configured to rotate relative to the frame about more than one rotational axis relative to the frame.

A35. The massage device of paragraph A34, wherein the multi-axis massage element is configured to rotate relative to the frame with one degree of rotational freedom during operative use of the massage device.

A36. The massage device of paragraph A34, wherein the multi-axis massage element is configured to rotate relative to the frame with more than one degree of rotational freedom, optionally with three degrees of rotational freedom, during operative use of the massage device.

A37. The massage device of any of paragraphs A34-A36, wherein the multi-axis massage element is configured to rotate relative to the frame about each of a plurality of axes of rotation, wherein one or more of the plurality of axes of rotation is a tilted axis of rotation that is nonparallel with one or both of a/the first axis of rotation and a/the second axis of rotation.

A38. The massage device of any of paragraphs A34-A37, wherein the multi-axis massage element is configured to rotate relative to the frame about a variable axis of rotation; and wherein the multi-axis massage element is configured such that an orientation of the variable axis of rotation relative to the frame may be selectively varied.

A39. The massage device of paragraph A38, wherein the variable axis of rotation is one or more of a/the first axis of rotation, a/the second axis of rotation, and a/the tilted axis of rotation.

A40. The massage device of any of paragraphs A38-A39, wherein the orientation of the variable axis of rotation relative to the frame is at least substantially fixed during operative use of the massage device.

A41. The massage device of any of paragraphs A38-A40, when dependent from paragraph A36, wherein the variable axis of rotation is an instantaneous axis of rotation of the multi-axis massage element.

A42. The massage device of any of paragraphs A38-A41, wherein the multi-axis massage element is configured such that the variable axis of rotation may assume one of a discrete plurality of orientations relative to the frame during operative use of the massage device.

A43. The massage device of any of paragraphs A38-A41, wherein the multi-axis massage element is configured such that the variable axis of rotation may assume one of a continuous plurality of orientations relative to the frame during operative use of the massage device.

A44. The massage device of paragraph A43, wherein the orientation of the variable axis of rotation relative to the frame is unconstrained.

A45. The massage device of any of paragraphs A38-A44, wherein one or both of the first support member and the second support member includes, and optionally is, a repositionable rotation support that supports the multi-axis massage element; wherein the repositionable rotation support is configured to permit selective repositioning of the variable axis of rotation relative to the frame.

A46. The massage device of paragraph A45, wherein the repositionable rotation support is configured to selectively rotate the variable axis of rotation relative to the frame, optionally while the massage device is not in operative use.

A47. The massage device of paragraph A46, wherein the repositionable rotation support is configured to selectively rotate the variable axis of rotation relative to the frame in discrete angular increments, optionally in one or more of 30-degree increments, 45-degree increments, 60-degree increments, and/or 90-degree increments.

A48. The massage device of paragraph A46, wherein the repositionable rotation support is configured to selectively rotate the variable axis of rotation relative to the frame to any orientation within a continuous range of motion of the repositionable rotation support.

A49. The massage device of any of paragraphs A45-A48, wherein the repositionable rotation support includes a repositioning mechanism that is configured to be selectively manipulated by the user to selectively adjust the orientation of the variable axis of rotation relative to the frame.

A50. The massage device of paragraph A49, wherein the repositioning mechanism biases the repositionable rotation support toward a configuration in which the variable axis of rotation is at least substantially fixed relative to the frame.

A51. The massage device of any of paragraphs A36-A50, wherein one or both of the first support member and the second support member includes a universal rotation support configured to enable the multi-axis massage element to rotate relative to the frame with more than one degree of rotational freedom.

A52. The massage device of paragraph A51, wherein the universal rotation support includes one or more of a ball joint, a spherical rolling joint, and a universal joint.

A53. The massage device of any of paragraphs A1-A52, wherein one or both of the first massage element and the second massage element has a shape that is one or more of spherical, ellipsoidal, conical, and cylindrical.

A54. The massage device of any of paragraphs A1-A53, wherein a/the shape of the first massage element is different than a/the shape of the second massage element.

A55. The massage device of paragraph A54, wherein one of the first massage element and the second massage element is at least substantially spherical; and wherein the other of the first massage element and the second massage element is at least substantially cylindrical.

A56. The massage device of any of paragraphs A1-A55, wherein each of the first massage element and the second massage element is formed of one or more of a plastic, a rubber, a foam, a metal, and wood.

A57. The massage device of any of paragraphs A1-A56, wherein the first massage element and the second massage element are formed of different materials.

A58. The massage device of paragraph A57, wherein one of the first massage element and the second massage element is formed of rubber; and wherein the other of the first massage element and the second massage element is formed of foam.

A59. The massage device of any of paragraphs A1-A58, wherein the first massage element and the second massage element are configured to exhibit distinct material properties; optionally wherein the material properties include one or more of compressibility, elastic modulus, and/or softness.

A60. The massage device of any of paragraphs A1-A59, wherein one or both of the first massage element and the second massage element includes a plurality of distinct massage components; wherein each massage component of the plurality of distinct massage components is configured to engage the limb during operative use of the massage device, optionally concurrently.

A61. The massage device of paragraph A60, wherein each massage component of the plurality of distinct massage components is configured to rotate with respect to at least one other massage component of the plurality of distinct massage components.

A62. The massage device of any of paragraphs A60-A61, wherein the plurality of massage components is configured to rotate relative to the frame at least substantially in unison.

A63. The massage device of any of paragraphs A1-A62, wherein the frame includes a first frame side; and wherein the frame further includes one or more of:

(i) a second frame side that is spaced apart from the first frame side;

(ii) a first frame end that extends from the first frame side; and

(iii) a second frame end that is spaced apart from the first frame end and that extends from one or both of the first frame side and the second frame side.

A64. The massage device of paragraph A63, wherein each of the first support member and the second support member extends from one or more of the first frame side, the second frame side, the first frame end, and the second frame end during operative use of the massage device.

A65. The massage device of any of paragraphs A63-A64, wherein each of the first support member and the second support member is operatively coupled to one or more of the first frame side, the second frame side, the first frame end, and the second frame end during operative use of the massage device.

A66. The massage device of any of paragraphs A63-A65, wherein one or both of the first support member and the second support member is operatively coupled to each of the first frame side and the second frame side during operative use of the massage device.

A67. The massage device of any of paragraphs A63-A66, wherein two or more of the first frame side, the second frame side, the first frame end, and the second frame end are integrally formed with one another.

A68. The massage device of any of paragraphs A63-A67, wherein the frame includes one or more frame transition regions; wherein each frame transition region joins two of the first frame side, the second frame side, the first frame end, and the second frame end to one another.

A69. The massage device of paragraph A68, wherein each frame transition region is at least partially curved.

A70. The massage device of any of paragraphs A63-A69, wherein one or more of the first frame side, the second frame side, the first frame end, and the second frame end is at least substantially straight.

A71. The massage device of any of paragraphs A63-A70, wherein one or more of the first frame side, the second frame side, the first frame end, and the second frame end is at least partially curved.

A72. The massage device of any of paragraphs A63-A71, wherein the first frame side and the second frame side extend at least substantially parallel to one another.

A73. The massage device of any of paragraphs A63-A72, wherein the first frame end and the second frame end extend at least substantially parallel to one another.

A74. The massage device of any of paragraphs A63-A73, wherein one or more of the first frame side, the second frame side, the first frame end, and the second frame end extend within a/the device plane.

A75. The massage device of any of paragraphs A63-A74, wherein one or both of the first frame end and the second frame end is fixedly coupled to one or both of the first frame side and the second frame side.

A76. The massage device of any of paragraphs A63-A75, wherein one or more of the first frame side, the second frame side, the first frame end, and the second frame end includes a plurality of distinct frame side segments that are one or more of movable relative to one another, disconnected from one another, and spaced apart from one another.

A77. The massage device of paragraph A76, wherein the second frame side includes a pair of the frame side segments that are spaced apart from one another; wherein the first support member extends from the first frame side to one of the pair of frame side segments; and wherein the second support member extends from the first frame side to the other of the pair of frame side segments.

A78. The massage device of any of paragraphs A76-A77, wherein each of the first frame side and the second frame side includes a respective plurality of frame side segments including a first respective frame side segment and a second respective frame side segment; and wherein the frame includes:

a first frame portion that includes the first respective frame side segment of the first frame side, the first frame end, and the first respective frame side segment of the second frame side; and

a second frame portion that includes the second respective frame side segment of the first frame side, the second frame end, and the second respective frame side segment of the second frame end; and

wherein the first frame portion and the second frame portion are configured to be selectively repositioned relative to one another to selectively adjust the selected separation distance.

A79. The massage device of paragraph A78, wherein the first massage element is supported by the first frame portion, and wherein the second massage element is supported by the second frame portion.

A80. The massage device of any of paragraphs A78-A79, wherein the first support member is operatively coupled to the first frame portion, and wherein the second support member is operatively coupled to the second frame portion.

A81. The massage device of any of paragraphs A63-A80, wherein one or both of the first support member and the second support member extends at least substantially parallel to one or both of the first frame end and the second frame end.

A82. The massage device of any of paragraphs A63-A81, wherein one or more of the first frame side, the second frame side, the first frame end, and the second frame end is configured to be gripped by the user to translate and/or rotate the massage device relative to the limb.

A83. The massage device of any of paragraphs A63-A82, wherein one or more of the first frame side, the second frame side, the first frame end, and the second frame end includes a grip feature that is configured to be gripped by the user during operative use of the massage device.

A84. The massage device of paragraph A83, wherein the grip feature is configured to enable the user to grip the massage device without interfering with the operation and/or rotation of the first massage element and/or the second massage element.

A85. The massage device of any of paragraphs A83-A84, wherein the grip feature includes one or more of a handle, a grip, and a surface that is configured to be gripped by the user during operative use of the massage device.

A86. The massage device of any of paragraphs A83-A85, wherein the grip feature is configured to be gripped by the user to selectively tilt the frame relative to the limb to adjust a/the limb angle during operative use of the massage device.

A87. The massage device of any of paragraphs A1-A86, wherein one or more of the first massage element, the first support member, the second massage element, and the second support member is configured to be selectively removed from the frame and/or operatively coupled to the frame.

A88. The massage device of any of paragraphs A1-A87, wherein one or both of the first support member and the second support member is formed of one or more of wood, a plastic, a metal, and aluminum.

A89. The massage device of any of paragraphs A63-A88, wherein one or more of the first frame side, the second frame side, the first frame end, the second frame end, and a/the one or more frame transition regions has a cross-sectional profile that is one or more of circular, elliptical, rectangular, square, and polygonal.

A90. The massage device of any of paragraphs A1-A89, wherein the massage device is configured to enable the selected separation distance to be selectively adjusted.

A91. The massage device of paragraph A90, wherein the massage device is disabled from being operatively utilized while the selected separation distance is selectively adjusted.

A92. The massage device of any of paragraphs A90-A91, wherein the massage device is configured such that the selected separation distance is at least partially restricted from being selectively adjusted while the massage device is being operatively utilized.

A93. The massage device of any of paragraphs A90-A92, further comprising at least one separation adjustment mechanism for adjusting the selected separation distance.

A94. The massage device of paragraph A93, wherein each separation adjustment mechanism of the at least one separation adjustment mechanism is configured to be selectively transitioned between a use configuration, in which the separation adjustment mechanism at least partially restricts the selected separation distance from being selectively adjusted, and an adjustment configuration, in which the selected separation distance may be selectively adjusted.

A95. The massage device of paragraph A94, wherein, when the at least one separation adjustment mechanism is in the use configuration, the at least one separation adjustment mechanism restricts the selected separation distance from being increased.

A96. The massage device of any of paragraphs A94-A95, wherein, when the at least one separation adjustment mechanism is in the use configuration, the at least one separation adjustment mechanism is configured to permit the selected separation distance to be selectively decreased.

A97. The massage device of any of paragraphs A94-A96, wherein, when the at least one separation adjustment mechanism is in the adjustment configuration, the at least one separation adjustment mechanism is configured to permit the selected separation distance to be selectively increased and decreased.

A98. The massage device of any of paragraphs A94-A97, wherein the massage device is disabled from being operatively utilized to massage the limb when the at least one separation adjustment mechanism is in the adjustment configuration.

A99. The massage device of any of paragraphs A94-A98, wherein the at least one separation adjustment mechanism is configured such that the selected separation distance is adjustable through a continuum of selected separation distances when the at least one separation adjustment mechanism is in the adjustment configuration.

A100. The massage device of any of paragraphs A94-A99, wherein the at least one separation adjustment mechanism is configured such that the selected separation distance is adjustable in discrete intervals when the at least one separation adjustment mechanism is in the adjustment configuration.

A101. The massage device of any of paragraphs A94-A100, wherein the at least one separation adjustment mechanism includes an adjustment mechanism actuator that is configured to be selectively manipulated by the user to transition the at least one separation adjustment mechanism between the use configuration and the adjustment configuration.

A102. The massage device of paragraph A101, wherein the adjustment mechanism actuator includes one or more of a cam lock mechanism, a twist-lock mechanism, a clamp screw mechanism, a set screw mechanism, a geared mechanism, and a ratchet mechanism.

A103. The massage device of any of paragraphs A93-A102, wherein the at least one separation adjustment mechanism is configured to be selectively transitioned between the use configuration and the adjustment configuration with one hand.

A104. The massage device of any of paragraphs A93-A103, wherein the at least one separation adjustment mechanism is configured to permit adjustment of the selected separation distance while the limb extends between the first massage element and the second massage element.

A105. The massage device of any of paragraphs A93-A94, wherein the at least one separation adjustment mechanism includes a plurality of separation adjustment mechanisms, and wherein the massage device is configured such that each separation adjustment mechanism may be selectively and independently transitioned between a/the use configuration and a/the adjustment configuration.

A106. The massage device of any of paragraphs A93-A105, wherein the at least one separation adjustment mechanism includes, and optionally is, one or both of:

(i) at least one support separation adjustment mechanism that is configured to enable one or both of the first support member and the second support member to be selectively repositioned relative to the frame to adjust the selected separation distance; and

(ii) at least one frame separation adjustment mechanism that is configured to enable adjustment of the selected separation distance via a selective reconfiguration of the frame.

A107. The massage device of paragraph A106, wherein the at least one support separation adjustment mechanism is configured to permit the selected separation distance to be continuously adjustable.

A108. The massage device of any of paragraphs A106-A107, wherein the at least one support separation adjustment mechanism is configured to permit the selected separation distance to be discretely adjustable.

A109. The massage device of any of paragraphs A106-A108, wherein the at least one frame separation adjustment mechanism is configured to permit the selected separation distance to be continuously adjustable.

A110. The massage device of any of paragraphs A106-A109, wherein the at least one frame separation adjustment mechanism is configured to permit the selected separation distance to be discretely adjustable.

A111. The massage device of any of paragraphs A106-A107, wherein the at least one separation adjustment mechanism includes the at least one support separation adjustment mechanism and the at least one frame separation adjustment mechanism.

A112. The massage device of paragraph A111, wherein the at least one support separation adjustment mechanism is configured to permit the selected separation distance to be continuously adjustable, and wherein the at least one frame separation adjustment mechanism is configured to permit the selected separation distance to be discretely adjustable.

A113. The massage device of paragraph A111, wherein the at least one support separation adjustment mechanism is configured to permit the selected separation distance to be discretely adjustable, and wherein the at least one frame separation adjustment mechanism is configured to permit the selected separation distance to be continuously adjustable.

A114. The massage device of any of paragraphs A106-A113, wherein the frame separation adjustment mechanism is configured to enable one or more of a/the first frame side, a/the second frame side, a/the first frame end, and a/the second frame end to be selectively repositioned relative to one another.

A115. The massage device of any of paragraphs A106-A114, wherein the at least one support separation adjustment mechanism is configured to permit one or both of the first support member and the second support member to be selectively and operatively coupled to and uncoupled from the frame when the at least one separation adjustment mechanism is in a/the adjustment configuration.

A116. The massage device of paragraph A115, wherein the at least one support separation adjustment mechanism is configured to permit one or both of the first support member and the second support member to be selectively and operatively coupled to the frame at any of a discrete plurality of predefined locations when the at least one separation adjustment mechanism is in the adjustment configuration.

A117. The massage device of paragraph A116, wherein the frame includes a plurality of spaced-apart support receivers, each configured to selectively support one of the first support member and the second support member; wherein the at least one support separation adjustment mechanism is configured to selectively retain one or both of the first support member and the second support member in one or more respective support receivers of the plurality of spaced-apart support receivers to selectively maintain the selected separation distance when the at least one support separation adjustment mechanism is in the use configuration; and wherein the at least one support separation adjustment mechanism is configured to selectively permit one or both of the first support member and the second support member to be selectively removed from the one or more respective support receivers of the plurality of spaced-apart support receivers to adjust the selected separation distance when the at least one support separation adjustment mechanism is in the adjustment configuration.

A118. The massage device of paragraph A117, wherein each support receiver of the plurality of spaced-apart support receivers includes a bore that extends at least partially, and optionally fully, through the frame.

A119. The massage device of any of paragraphs A117-A118, wherein one or both of a/the first frame side and a/the second frame side includes the plurality of spaced-apart support receivers.

A120. The massage device of any of paragraphs A117-A118, wherein each support receiver of the plurality of spaced-apart support receivers includes an extension that is operatively coupled to, and extends away from, the frame, optionally from one of a/the first frame side and a/the second frame side, and wherein one or both of the first support member and the second support member includes a receiver notch that is configured to operatively engage a respective support receiver of the plurality of spaced-apart support receivers when the support separation adjustment mechanism is in the use configuration.

A121. The massage device of any of paragraphs A106-A120, wherein the at least one support separation adjustment mechanism is configured to permit one or both of the first support member and the second support member to be operatively coupled to the frame at any of a continuum of locations when the at least one support separation adjustment mechanism is in a/the adjustment configuration.

A122. The massage device of paragraph A121, wherein the at least one support separation adjustment mechanism includes a support member collar that is operatively coupled to one of the first support member and the second support member and that extends at least substantially circumferentially around the frame, optionally around one of a/the first frame side and a/the second frame side, to operatively couple the one of the first support member and the second support member to the frame.

A123. The massage device of paragraph A122, wherein the support member collar includes a collar lock mechanism for selectively tightening or loosening the support member collar around the frame.

A124. The massage device of paragraph A123, wherein the collar lock mechanism is configured to selectively retain the support member collar to be continuously adjustable relative to the frame.

A125. The massage device of any of paragraphs A123-A124, wherein the collar lock mechanism is configured to selectively transition the support separation adjustment mechanism between a/the use configuration and a/the adjustment configuration.

A126. The massage device of any of paragraphs A123-A125, wherein a/the at least one adjustment mechanism actuator includes, and optionally is, the collar lock mechanism.

A127. The massage device of any of paragraphs A106-A126, wherein the at least one frame separation adjustment mechanism is configured to selectively permit and/or restrict relative motion of a/the first frame portion and a/the second frame portion to enable selective adjustment of the selected separation distance.

A128. The massage device of paragraph A127, wherein one or both of a/the first frame side and a/the second frame side is an expanding frame side configured to selectively expand and retract in length to adjust the selected separation distance when the at least one frame separation adjustment mechanism is in a/the adjustment configuration.

A129. The massage device of paragraph A128, wherein the at least one frame separation adjustment mechanism is configured to selectively permit the expanding frame side to expand and contract when the at least one frame separation adjustment mechanism is in the adjustment configuration, and wherein the at least one frame separation adjustment mechanism is configured to restrict the expanding frame side from expanding or contracting when the at least one frame separation adjustment mechanism is in the use configuration.

A130. The massage device of any of paragraphs A128-A129, wherein the expanding frame side includes two or more distinct frame side segments of a/the plurality of frame side segments that are configured to move relative to one another to selectively lengthen or shorten the expanding frame side.

A131. The massage device of paragraph A130, wherein the two or more frame side segments are configured to expand and/or contract in a telescoping manner.

A132. The massage device of paragraph A131, wherein each frame side segment of the two or more frame side segments one or both of:

(i) is at least partially received in at least one other frame side segment of the two or more frame side segments; and

(ii) receives at least a portion of at least one other frame side segment of the two or more frame side segments.

A133. The massage device of any of paragraphs A130-A131, wherein each frame side segment of the two or more frame side segments is positioned exterior of and adjacent to at least one other frame side segment of the two or more frame side segments.

A134. The massage device of any of paragraphs A1-A133, further comprising a mounting structure configured to selectively and operatively couple the massage device to a support structure during operative use of the massage device.

A135. The massage device of paragraph A134, wherein the mounting structure includes one or more of a bracket, a clamp, a strap, and a suction cup.

A136. The massage device of any of paragraphs A134-A135, wherein the support structure includes one or more of a piece of furniture, a door, a table, and a chair.

B1. A method of utilizing a massage device to massage a limb of a user, the method comprising:

positioning the limb of the user between a first massage element and a second massage element of the massage device; and

applying a compressive force to the limb with each of the first massage element and the second massage element;

wherein the massage device is the massage device of any of paragraphs A1-A136.

B2. The method of paragraph B1, wherein the applying the compressive force to the limb includes translating the frame relative to the limb along a direction at least substantially parallel to a/the limb axis.

B3. The method of any of paragraphs B1-B2, wherein the applying the compressive force to the limb includes rotating the frame relative to the limb about a/the limb axis.

B4. The method of any of paragraphs B1-B3, wherein the applying the compressive force to the limb includes selectively adjusting a/the limb angle while the limb is inserted between the first massage element and the second massage element.

B5. The method of any of paragraphs B1-B4, further comprising, prior to the positioning the limb between the first massage element and the second massage element, selectively adjusting the selected separation distance with a/the at least one separation adjustment mechanism.

B6. The method of paragraph B5, wherein the adjusting the selected separation distance includes one or more of:

(i) transitioning the at least one separation adjustment mechanism to a/the adjustment configuration;

(ii) with the at least one separation adjustment mechanism in the adjustment configuration, repositioning the first massage element relative to the second massage element to adjust the selected separation distance; and

(iii) transitioning the at least one separation adjustment mechanism to a/the use configuration.

B7. The method of any of paragraphs B5-B6, wherein the adjusting the selected separation distance includes adjusting such that the selected separation distance is at least substantially equal to a/the limb width of the limb.

B8. The method of any of paragraphs B5-B7, wherein the adjusting the selected separation distance includes adjusting such that the selected separation distance is larger than a/the limb width of the limb.

B9. The method of any of paragraphs B1-B8, further comprising, prior to the positioning the limb between the first massage element and the second massage element, adjusting a/the variable axis of rotation of one or both of the first massage element and the second massage element, optionally with a/the repositionable rotation support.

B10. The method of any of paragraphs B1-B9, further comprising, prior to the applying the compressive force to the limb, operatively coupling the massage device to a/the support structure, optionally with a/the mounting structure.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more.” and “and/or” are open-ended expressions that are both conjunctive and disjunctive in operation. For example, each of the expressions “at least one of A, B. and C,” “at least one of A, B, or C,” “one or more of A, B, and C,” “one or more of A, B, or C” and “A, B, and/or C” may mean A alone, B alone, C alone, A and B together, A and C together, B and C together, A, B, and C together, and optionally any of the above in combination with at least one other entity.

As used herein. “at least substantially,” when modifying a degree or relationship, includes not only the recited “substantial” degree or relationship, but also the full extent of the recited degree or relationship. A substantial amount of a recited degree or relationship may include at least 75% of the recited degree or relationship. For example, an object that is at least substantially formed from a material includes an object for which at least 75% of the object is formed from the material and also includes an object that is completely formed from the material. As another example, a first direction that is at least substantially parallel to a second direction includes a first direction that forms an angle with respect to the second direction that is at most 22.5 degrees and also includes a first direction that is exactly parallel to the second direction. As another example, a first length that is substantially equal to a second length includes a first length that is at least 75% of the second length, a first length that is equal to the second length, and a first length that exceeds the second length such that the second length is at least 75% of the first length.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function.

It is also within the scope of the present disclosure that elements, components, and/or other recited subject matter that is recited as being adapted to perform a particular function may additionally or alternatively be described as being configured to perform that function, and vice versa.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A massage device for massaging a limb of a user, the massage device comprising:
a frame;
a first massage element operatively supported by the frame and configured to rotate relative to the frame about a first axis of rotation; and
a second massage element operatively supported by the frame and configured to rotate relative to the frame about a second axis of rotation;
wherein one of the first massage element and the second massage element is at least substantially spherical wherein the other of the first massage element and the second massage element is at least substantially cylindrical;
wherein the first massage element is supported on a first support member that is operatively coupled to the frame; wherein the second massage element is supported on a second support member that is operatively coupled to the frame; wherein the first massage element and the second massage element are selectively maintained at a selected separation distance from one another;
wherein the massage device further comprises at least one separation adjustment mechanism for adjusting the selected separation distance; wherein each separation adjustment mechanism of the at least one separation adjustment mechanism is configured to be selectively transitioned between a use configuration, in which the at least one separation adjustment mechanism at least partially restricts the selected separation distance from being selectively adjusted, and an adjustment configuration, in which the selected separation distance may be selectively adjusted; wherein, when the at least one separation adjustment mechanism is in the use configuration, the at least one separation adjustment mechanism restricts the selected separation distance from being increased; and
wherein the massage device is configured such that, during operative use of the massage device to massage the limb, the massage device is positioned such that the limb extends between the first massage element and the second massage element and such that each of the first massage element and the second massage element engages the limb to exert a compressive force on the limb as the frame is translated relative to the limb.

2. The massage device of claim 1, wherein one or both of the first massage element and the second massage element is a multi-axis massage element that is configured to rotate relative to the frame about more than one rotational axis relative to the frame.

3. The massage device of claim 2, wherein the multi-axis massage element is configured to rotate relative to the frame with one degree of rotational freedom during operative use of the massage device; wherein the multi-axis massage element is configured to rotate relative to the frame about a variable axis of rotation; wherein the multi-axis massage element is configured such that an orientation of the variable axis of rotation relative to the frame may be selectively varied; and wherein the orientation of the variable axis of rotation relative to the frame is at least substantially fixed during operative use of the massage device.

4. The massage device of claim 3, wherein one or both of the first support member and the second support member includes a repositionable rotation support that supports the multi-axis massage element; wherein the repositionable rotation support is configured to permit selective repositioning of the variable axis of rotation relative to the frame.

5. The massage device of claim 4, wherein the repositionable rotation support is configured to selectively rotate the variable axis of rotation relative to the frame in discrete angular increments.

6. The massage device of claim 2, wherein the multi-axis massage element is configured to rotate relative to the frame with three degrees of rotational freedom, during operative use of the massage device; and wherein one or both of the first support member and the second support member includes a universal rotation support configured to enable the multi-axis massage element to rotate relative to the frame with more than one degree of rotational freedom.

7. The massage device of claim 1, wherein the at least one separation adjustment mechanism is configured such that the selected separation distance is adjustable through a continuum of selected separation distances when the at least one separation adjustment mechanism is in the adjustment configuration.

8. The massage device of claim 1, wherein the at least one separation adjustment mechanism is configured such that the selected separation distance is adjustable in discrete intervals when the at least one separation adjustment mechanism is in the adjustment configuration.

9. The massage device of claim 1, wherein the at least one separation adjustment mechanism includes an adjustment mechanism actuator that is configured to be selectively manipulated by the user to transition the at least one separation adjustment mechanism between the use configuration and the adjustment configuration.

10. The massage device of claim 1, wherein the at least one separation adjustment mechanism includes, and optionally is, one or both of:
(i) at least one support separation adjustment mechanism that is configured to enable one or both of the first support member and the second support member to be selectively repositioned relative to the frame to adjust the selected separation distance; and
(ii) at least one frame separation adjustment mechanism that is configured to enable adjustment of the selected separation distance via a selective reconfiguration of the frame.

11. The massage device of claim 10, wherein the at least one support separation adjustment mechanism is configured to permit one or both of the first support member and the second support member to be selectively and operatively coupled to and uncoupled from the frame when the at least one separation adjustment mechanism is in the adjustment configuration.

12. The massage device of claim 10, wherein the at least one support separation adjustment mechanism is configured to permit one or both of the first support member and the second support member to be selectively and operatively coupled to the frame at any of a discrete plurality of predefined locations when the at least one separation adjustment mechanism is in the adjustment configuration.

13. The massage device of claim 10, wherein the at least one support separation adjustment mechanism is configured to permit one or both of the first support member and the second support member to be operatively coupled to the frame at any of a continuum of locations when the at least one support separation adjustment mechanism is in the adjustment configuration.

14. The massage device of claim 10, wherein the frame includes:
(i) a first frame side;
(ii) a second frame side that is spaced apart from the first frame side;
(iii) a first frame end that extends from the first frame side; and
(iv) a second frame end that is spaced apart from the first frame end and that extends from one or both of the first frame side and the second frame side;
wherein each of the first frame side and the second frame side includes a respective plurality of frame side segments including a rust respective frame side segment and a second respective frame side segment; wherein the frame further includes:
a first frame portion that includes the first respective frame side segment of the first frame side, the first frame end, and the first respective frame side segment of the second frame side; and
a second frame portion that includes the second respective frame side segment of the first frame side, the second frame end, and the second respective frame side segment of the second frame end;
wherein the first support member is operatively coupled to the first frame portion, and wherein the second support member is operatively coupled to the second frame portion;
wherein the first frame portion and the second frame portion are configured to be selectively repositioned relative to one another to selectively adjust the selected separation distance; and
wherein the at least one frame separation adjustment mechanism is configured to selectively permit and restrict relative motion of the first frame portion and the second frame portion to enable selective adjustment of the selected separation distance.

15. The massage device of claim 14, wherein one or both of the first frame side and the second frame side is an expanding frame side configured to selectively expand and retract in length to adjust the selected separation distance when the at least one frame separation adjustment mechanism is in the adjustment configuration; wherein the expanding frame side includes two or more distinct frame side segments of the plurality of frame side segments that are configured to move relative to one another to selectively lengthen or shorten the expanding frame side.

16. The massage device of claim 10, wherein the at least one separation adjustment mechanism includes the at least one support separation adjustment mechanism and the at least one frame separation adjustment mechanism.

17. The massage device of claim 16, wherein one of:
(i) the at least one support separation adjustment mechanism is configured to permit the selected separation distance to be continuously adjustable, and the at least one frame separation adjustment mechanism is configured to permit the selected separation distance to be discretely adjustable; and
(ii) the at least one support separation adjustment mechanism is configured to permit the selected separation distance to be discretely adjustable, and the at least one frame separation adjustment mechanism is configured to permit the selected separation distance to be continuously adjustable.

18. A method of utilizing a massage device to massage a limb of a user, the method comprising:
positioning the limb of the user between a first massage element and a second massage element of the massage device; and
applying a compressive force to the limb with each of the first massage element and the second massage element;
wherein the massage device is the massage device of claim 1.

19. The method of claim 18, wherein the method further comprises, prior to the positioning the limb between the first massage element and the second massage element, selectively adjusting the selected separation distance with the at least one separation adjustment mechanism; wherein the adjusting the selected separation distance includes one or more of:
(i) transitioning the at least one separation adjustment mechanism to the adjustment configuration;
(ii) with the at least one separation adjustment mechanism in the adjustment configuration, repositioning the first massage element relative to the second massage element to adjust the selected separation distance; and
(iii) transitioning the at least one separation adjustment mechanism to the use configuration.

20. The method of claim 18, wherein one or both of the first massage element and the second massage element is a multi-axis massage element that is configured to rotate relative to the frame about more than one rotational axis relative to the frame; wherein the multi-axis massage element is configured to rotate relative to the frame about a variable axis of rotation; and wherein the method further comprises, prior to the positioning the limb between the first massage element and the second massage element, adjusting the variable axis of rotation of one or both of the first massage element and the second massage element.
